(19) United States
(12) Patent Application Publication
(10) Pub. No.: US 2024/0252931 A1
(43) Pub. Date: Aug. 1, 2024

(54) NON-TRANSITORY COMPUTER READABLE MEDIUM, INFORMATION PROCESSING METHOD, AND INFORMATION PROCESSING SYSTEM

(71) Applicant: CYGAMES, INC., Tokyo (JP)

(72) Inventors: Ryuhei Kawaguchi, Tokyo (JP); Masatoshi Nishimura, Tokyo (JP); Hikaru Uchiyama, Tokyo (JP)

(73) Assignee: CYGAMES, INC., Tokyo (JP)

(21) Appl. No.: 18/631,926

(22) Filed: Apr. 10, 2024

Related U.S. Application Data
(63) Continuation of application No. PCT/JP2022/037883, filed on Oct. 11, 2022.

(30) Foreign Application Priority Data
Oct. 14, 2021 (JP) 2021-169124

(51) Int. Cl. A63F 13/70

(52) U.S. Cl. CPC A63F 13/70

(57) ABSTRACT

A non-transitory computer readable medium stores a program causing a computer to execute: processing for enabling a special item in which an element for use in first game content can be stocked and that is usable as an item for second game content; and processing for stocking the element in the special item in the case where a prescribed condition is satisfied.

### CROSS REFERENCE TO RELATED APPLICATIONS

This application is a continuation application of International Application No. PCT/JP2022/037883, filed on Oct. 11, 2022, which claims priority to Japanese Patent Application No. 2021-169124, filed on Oct. 14, 2021, the entire contents of which are incorporated by reference herein.

### BACKGROUND ART

### Technical Field

The present invention relates to information processing programs, information processing methods, and information processing systems.

There has hitherto been a known system in which amounts of an in-game currency acquired in a game via treasure boxes, selling, and events and exceeding an upper limit of the amount that can be possessed by a player are automatically transferred to a bank, as disclosed, for example, in Non-Patent Literature 1.

### CITATION LIST

### Non-Patent Literature

Non-Patent Literature 1: GameCenter GX strategies and analysis, [Romancing Sa⋅Ga 3] possessed money, bank, and warehouse, [online], Apr. 9, 2021, [retrieved on Oct. 6, 2021], Internet <URL: https://gamecentergx.at-ninja.jp/rs3/bank.html>

### SUMMARY OF INVENTION

### Technical Problem

In the system disclosed in Non-Patent Literature 1, amounts of the in-game currency exceeding the upper limit of possession are just automatically accumulated in the bank, while not being utilized for other purposes in the game. Thus, there has been demand for further improvement in game intricacy

It is an object of the present invention to provide an information processing program, an information processing method, and an information processing system that make it possible to improve game intricacy.

### Solution to Problem

In order to solve the problem described above, an information processing program causes a computer to carry out:
processing for enabling a special item in which an element for use in first game content can be stocked and that is usable as an item for second game content; and
processing for stocking the element in the special item in the case where a prescribed condition is satisfied.

Furthermore, the second content may be a customization function that makes it possible to customize a game space,
the special item may be a stock item that can be installed in the game space,
the element may be an asset of a player, and
in the processing for stocking, in the case where the special item has been enabled and the asset has reached an upper limit value of possession by the player, the asset may be automatically stocked in the stock item irrespective of whether or not the stock item has been installed in the game space.

Furthermore, the computer may be caused to carry out:
processing for changing the appearance of the stock item installed in the game space in accordance with the stock amount in the stock item.

Furthermore, the computer may be caused to carry out:
processing for withdrawing the asset stocked in the stock item in the first game content or the second game content irrespective of whether or not the stock item has been installed in the game space.

Furthermore, the computer may be caused to carry out:
processing for saving the asset exceeding the upper limit value of possession or an upper limit value of stock in the stock item in third game content in the case where the stock item has not been enabled or in the case where the stock amount of the asset has reached the upper limit value of stock, and
in the processing for withdrawing, it may be prohibited in the first game content to withdraw the asset saved in the third game content.

Furthermore, the processing for withdrawing may be executable via a special withdrawal operating part that functions in the case where the stock item has been enabled in the first game content.

Furthermore, the first game content may be a function for purchasing an in-game item, and
the computer may be caused to carry out:
processing for displaying the special withdrawal operating part on a display when the asset is insufficient for purchasing the item.

In order to solve the problem described above, an information processing method is an information processing method that is carried out by one or more computers, the information processing method including:
processing for enabling a special item in which an element for use in first game content can be stocked and that is usable as an item for second game content; and
processing for stocking the element in the special item in the case where a prescribed condition is satisfied.

In order to solve the problem described above, an information processing system is an information processing system including one or more computers,
wherein the computer carries out:
processing for enabling a special item in which an element for use in first game content can be stocked and that is usable as an item for second game content; and
processing for stocking the element in the special item in the case where a prescribed condition is satisfied.

### Effects of Disclosure

The present invention makes it possible to improve game intricacy.

### BRIEF DESCRIPTION OF DRAWINGS

FIG. 1 is an explanatory illustration schematically showing the configuration of an information processing system.

FIG. 2A is a diagram for explaining the hardware configuration of a player terminal.

FIG. 2B is a diagram for explaining the hardware configuration of a server.

FIG. 3A is an illustration for explaining an example home screen.

FIG. 3B is an illustration for explaining an example ally-character confirmation screen.

FIG. 4 is an illustration for explaining an example room screen.

FIG. 5 is an illustration for explaining an example menu screen.

FIG. 6 is an illustration for explaining an example currency shop screen.

FIG. 7 is an illustration for explaining an example first-currency purchase screen.

FIG. 8 is a first illustration for explaining an example present screen.

FIG. 9A is an illustration for explaining an example quest screen for a normal quest.

FIG. 9B is an illustration for explaining an example quest selection screen for a normal quest.

FIG. 9C is an illustration for explaining an example party selection screen.

FIG. 10A is an illustration for explaining an example battle screen.

FIG. 10B is an illustration for explaining an example result screen.

FIG. 10C is an illustration for explaining an example report screen.

FIG. 11 is a second illustration for explaining an example present screen.

FIG. 12 is a first illustration for explaining an example room menu screen.

FIG. 13 is a second illustration for explaining an example room menu screen.

FIG. 14A is a first illustration for explaining an example change in the external shape of first-currency stock furniture.

FIG. 14B is a second illustration for explaining an example change in the external shape of first-currency stock furniture.

FIG. 14C is a third illustration for explaining an example change in the external shape of first-currency stock furniture.

FIG. 15 is an illustration for explaining an example first-currency withdrawal dialog screen.

FIG. 16 is an illustration for explaining an example withdrawal result screen.

FIG. 17 is an illustration for explaining an example over-upper-limit dialog screen.

FIG. 18 is a first illustration for explaining an example skipping-result dialog screen.

FIG. 19 is a second illustration for explaining an example skipping-result dialog screen.

FIG. 20 is an illustration for explaining an example setting screen.

FIG. 21 is an illustration for explaining an example first-currency-insufficiency dialog screen.

FIG. 22 is a diagram for explaining the configuration of a memory at the player terminal as well as functions thereof as a computer.

FIG. 23 is a diagram for explaining the configuration of a memory at the server as well as the functions thereof as a computer.

FIG. 24 is a sequence chart for explaining basic processes at the player terminal and the server.

FIG. 25 is a flowchart for explaining an example first asset control process.

FIG. 26 is a flowchart for explaining an example appearance changing process.

FIG. 27 is a flowchart for explaining an example second asset control process.

FIG. 28 is a flowchart for explaining an example third asset control process.

### DESCRIPTION OF EMBODIMENTS

An aspect of an embodiment of the present invention will be described below in detail with reference to the accompanying drawings. The dimensions, materials, other specific numerical values, etc. given in this embodiment are merely examples for facilitating understanding, and do not limit the present invention unless otherwise specifically mentioned. In the present description and the drawings, elements having substantially the same functions and configurations have the same reference signs attached thereto and are not described repeatedly, and elements that are not directly relevant to the present invention are not shown.

### (Overall Configuration of Information Processing System S)

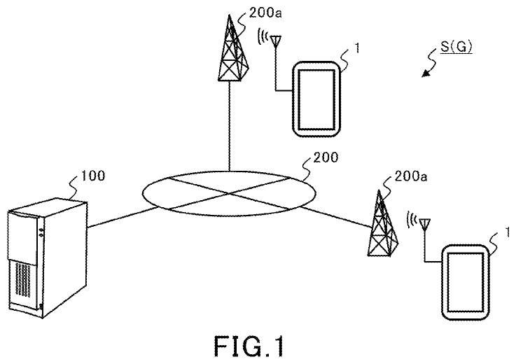

FIG. 1 is an explanatory illustration schematically showing the configuration of an information processing system S. The information processing system S is what is called a client-server system including player terminals 1, a server 100, and a communication network 200 having communication base stations 200a.

The player terminals (information processing devices) 1 can establish communication with the server 100 via the communication network 200. The player terminals 1 include a wide range of electronic appliances that are capable of communicatively connecting to the server 100 in a wireless or wired manner. Examples of the player terminals 1 include smartphones, mobile phones, tablet devices, personal computers, and game machines. This embodiment will be described in the context of a case where smartphones are used as the player terminals 1.

The server 100 is communicatively connected to the plurality of player terminals 1. The server 100 accumulates various kinds of information (hereinafter referred to as player information) for each item of player identification information (hereinafter referred to as a player ID) for identifying a player who plays a game.

The communication base stations 200a are connected to the communication network 200, and send information to and receive information from the player terminals 1 in a wireless manner. The communication network 200 is implemented by a mobile phone network, an Internet network, a local area network (LAN), a special circuit, or the like, and realizes wireless or wired communicative connection between the player terminals 1 and the server 100.

In the information processing system S in this embodiment, the player terminals 1 and the server 100 function as game devices G. The player terminals 1 and the server 100 individually share roles for controlling the proceeding of the game, and it becomes possible to proceed with the game through cooperation between the player terminals 1 and the server 100.

### (Hardware Configurations of Player Terminals 1 and Server 100)

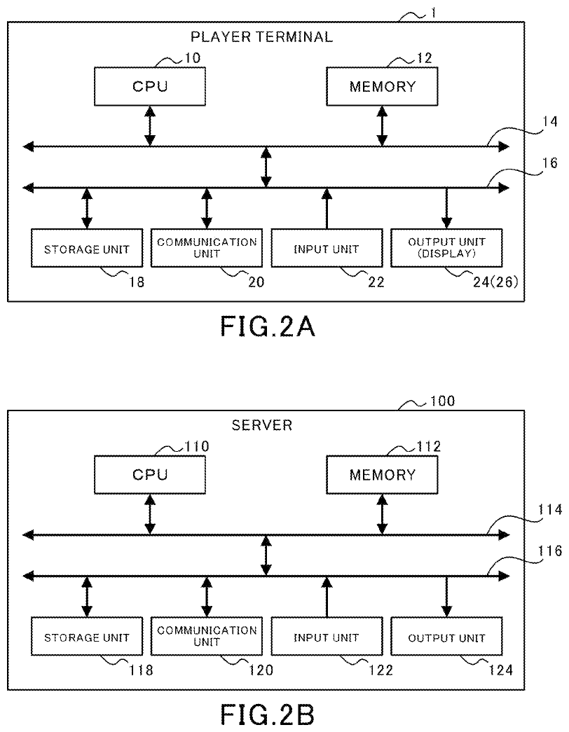

FIG. 2A is a diagram for explaining the hardware configuration of a player terminal 1. Furthermore, FIG. 2B is a diagram for explaining the hardware configuration of the server 100. As shown in FIG. 2A, the player terminal 1 is configured to include one or more central processing units (CPUs) 10, a memory 12, a bus 14, an input/output interface 16, a storage unit 18, a communication unit 20, an input unit 22, and an output unit 24.

Furthermore, as shown in FIG. 2B, the server 100 is configured to include one or more CPUs 110, a memory 112, a bus 114, an input/output interface 116, a storage unit 118, a communication unit 120, an input unit 122, and an output unit 124.

Note that the configurations and functions of the CPUs 110, the memory 112, the bus 114, the input/output interface 116, the storage unit 118, the communication unit 120, the input unit 122, and the output unit 124 of the server 100 are substantially the same as those of the CPUs 10, the memory 12, the bus 14, the input/output interface 16, the storage unit 18, the communication unit 20, the input unit 22, and the output unit 24 of the player terminal 1, respectively. Therefore, the following description will be directed to the hardware configuration of the player terminal 1, while omitting a description of the server 100.

The CPUs 10 run a program stored in the memory 12 to control the proceeding of the game. The memory 12 is configured of a read only memory (ROM) or a random access memory (RAM), and stores the program and various kinds of data needed for controlling the proceeding of the game. The memory 12 is connected to the CPU 10 via the bus 14.

The input/output interface 16 is connected to the bus 14. The storage unit 18, the communication unit 20, the input unit 22, and the output unit 24 are connected to the input/output interface 16.

The storage unit 18 is configured of a semiconductor memory such as a dynamic random access memory (DRAM), and stores various kinds of programs and data. In the player terminal 1, the programs and data stored in the storage unit 18 are loaded into the memory 12 (RAM) by the CPUs 10.

The communication unit 20 is communicatively connected to a communication base station 200a in a wireless manner, and sends information to and receives information from the server 100 via the communication network 200, such as various kinds of data and programs. In the player terminal 1, programs, etc. received from the server 100 are stored in the memory 12 or the storage unit 18.

The input unit 22 is configured of a unit via which player operations are input (operations are accepted), such as a touch panel, buttons, a keyboard, a mouse, a cross keypad, or an analog controller. Alternatively, the input unit 22 may be a special controller provided at the player terminal 1 or connected (externally connected) to the player terminal 1. Yet alternatively, the input unit 22 may be configured of an acceleration sensor that detects tilting or movement of the player terminal 1 or a microphone that detects player's voice. That is, examples of the input unit 22 include a wide range of devices that enable the input of player's intents in distinguishable manners.

The output unit 24 is configured to include a display device and a speaker. Note that the output unit 24 may be a device connected (externally connected) to the player terminal 1. In this embodiment, the player terminal 1 includes a display 26 as the output unit 24 and includes a touch panel as the input unit 22, the touch panel being provided so as to be stacked on the display 26.

### (Game Specifics)

Next, the specifics of the game provided by the information processing system S (game devices G) in this embodiment will be described by using an example. In this embodiment, what are called battle games, in which ally characters play battles against enemy characters, are provided. Specifically, in the game in this embodiment, a plurality of ally characters are provided. The player forms a party by selecting a plurality of (five here) ally characters from the provided ally characters. Furthermore, the player can play a plurality of kinds of battle games involving different enemy characters or having different difficulty levels. The objective of a battle game is that the ally characters formed into the party beat the enemy characters to acquire rewards.

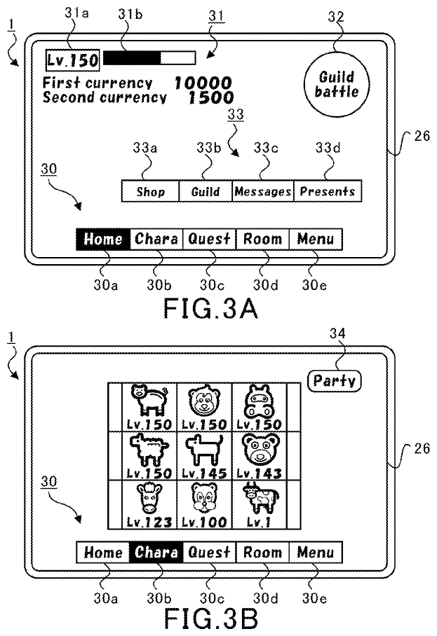

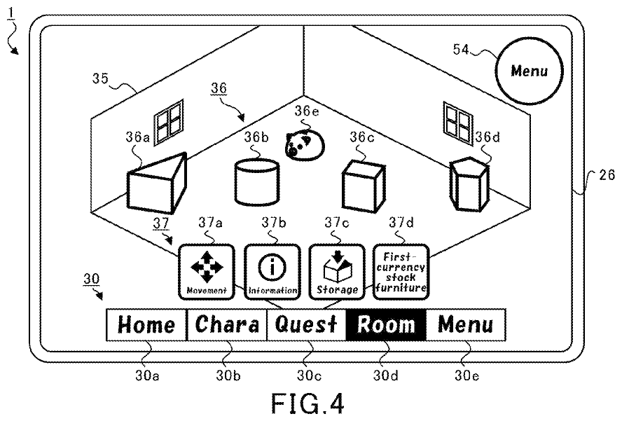

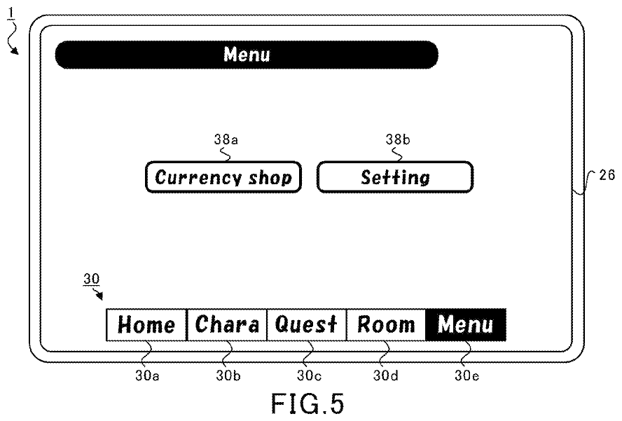

FIG. 3A is an illustration for explaining an example home screen. FIG. 3B is an illustration for explaining an example ally-character confirmation screen. FIG. 4 is an illustration for explaining an example room screen. FIG. 5 is an illustration for explaining an example menu screen. The display 26 of the player terminal 1 displays game screens. In this embodiment, the game screens are broadly classified into normal screens and battle screens.

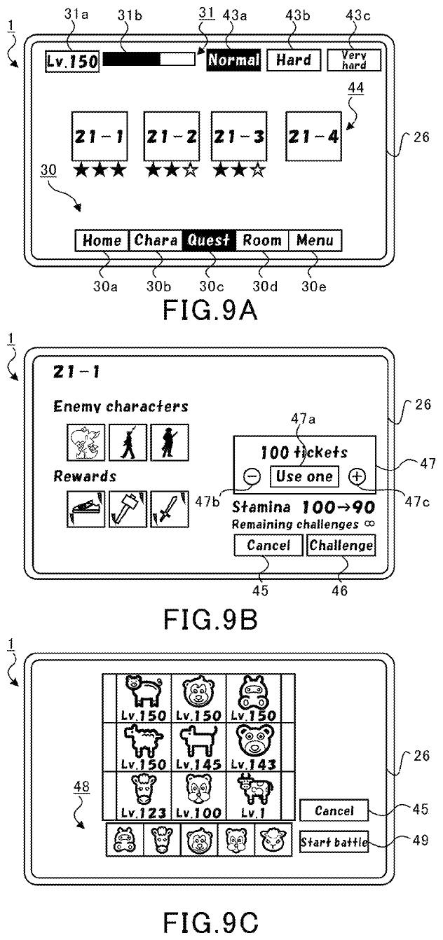

The normal screens are mainly screens for allowing the player to make various kinds of settings and to confirm information. Meanwhile, the battle screens are screens that are displayed on the display 26 from the start to the end of a battle game. Here, all the screens other than the battle screens are the normal screens. A plurality of screens are provided as the normal screens, such as the home screen shown in FIG. 3A, the ally-character confirmation screen shown in FIG. 3B, a quest screen (see FIG. 9A), a shop screen (not shown), a guild screen (not shown), a room screen (FIG. 4), and a menu screen (FIG. 5).

In the normal screens, for example as shown in FIG. 3A, a menu bar 30 is displayed in a lower part of the display 26. In the menu bar 30, a plurality of operating parts that can be operated (tapped) by the player are provided. In the menu bar 30, the following operating parts are provided: a home-screen selection operating part 30a labelled as “Home”; an ally-character-confirmation-screen selection operating part 30b labelled as “Characters”; a quest-screen selection operating part 30c labelled as “Quest”; a room-screen selection operating part 30d labelled as “Room”; and a menu-screen selection operating part 30e labelled as “Menu”.

When the home-screen selection operating part 30a is tapped, the home screen shown in FIG. 3A is displayed on the display 26. Furthermore, when the ally-character-confirmation-screen selection operating part 30b is tapped, the ally-character confirmation screen shown in FIG. 3B is displayed on the display 26. Similarly, when the quest-screen selection operating part 30c is tapped, the quest screen shown in FIG. 9A is displayed on the display 26. Furthermore, when the room-screen selection operating part 30d is tapped, the room screen shown in FIG. 4 is displayed on the display 26. Furthermore, when the menu-screen selection operating part 30e is tapped, the menu screen shown in FIG. 5 is displayed on the display 26. Although not described in detail, it is possible to make settings for the game and to confirm various kinds of information via the menu screen.

In the menu bar 30, the operating part corresponding to each screen is indicated in a highlighted manner so that the screen being displayed on the display 26 can be distinguished.

The home screen shown in FIG. 3A corresponds to an initial screen, and a header display area 31 is provided in an upper part thereof. In the header display area 31, the following items of information are displayed: level information 31a indicating the player level associated with the player ID; a stamina display bar 31b indicating the stamina of the player associated with the player ID; and the possessed amounts of a first currency and a second currency, associated with the player ID.

The stamina is a parameter necessary for playing a battle game. In this embodiment, a plurality of kinds of battle games are provided, and each of the battle games has set therefor a value of stamina consumption needed for a play, the number of challenges per day, etc. In the case of playing a battle game having set therefor a value of stamina consumption needed for a play, the player has to consume stamina in order to play the battle game, and thus the player cannot play the battle game in the case where the stamina is insufficient.

Although not described in detail, when the player clears a battle game, the player can acquire a prescribed value as a player experience value. Furthermore, the player level is advanced each time the player experience value reaches a certain value. A management upper limit value is set for the player level, which prohibits the player level from being advanced beyond the set management upper limit value even if a player experience value is acquired. The management upper limit value is set by the administrator and is increased at prescribed timings. For example, the management upper limit value is manually updated by the administrator in regular updates that are performed, for example, once a month. Without limitation to the above example, however, for example, the management upper limit value may be mechanically and automatically updated by using a program in regular updates that are performed, for example, once a month. In this program, the period of updating and the content of updating are set in advance.

The player level has set therefor a stamina upper limit value, and the stamina upper limit value becomes higher as the player level is advanced. Stamina is recovered by a prescribed value (e.g., one point) per certain time (e.g., five minutes) within the upper limit. In the stamina display bar 31b, the current remaining amount of stamina is displayed so as to be visually recognized in relation to the stamina upper value.

The first currency and the second currency are currencies that are available only in the game. For example, when a battle game is cleared, a prescribed amount of the first currency can be acquired in accordance with the cleared battle game. The second currency can be acquired for free or for a charge. Although the first currency and the second currency can be acquired in various ways, detailed descriptions thereof will be omitted.

Furthermore, there are cases where a notification selection operating part 32 is displayed at the right end of the home screen. Although not described in detail, in the case where a guild battle is being played, which is a kind of battle game, a notification selection operating part 32 labelled as “Guild battle” is displayed.

A home menu 33 is displayed between the menu bar 30 and the notification selection operating part 32 in the home screen. In the home menu 33, the following operating parts are provided: a shop-screen selection operating part 33a labelled as “Shop”; a guild-screen selection operating part 33b labelled as “Guild”; a message-screen selection operating part 33c labelled as “Messages”; and a present-screen selection operating part 33d labelled as “Presents”.

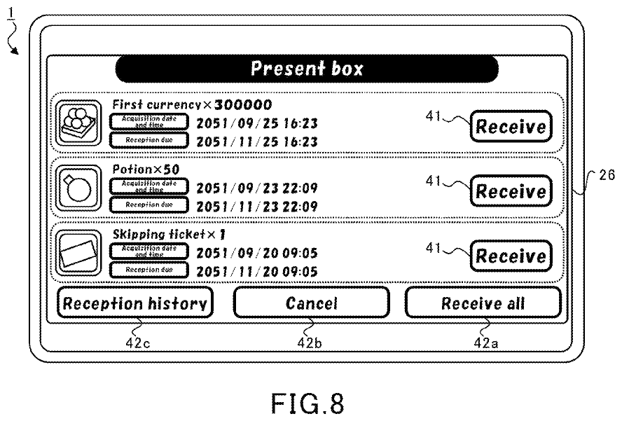

When the shop-screen selection operating part 33a is tapped, a shop screen via which items can be purchased, which is not shown, is displayed. Furthermore, when the guild-screen selection operating part 33b is tapped, a guild screen, which is not shown, is displayed on the display 26. Furthermore, when the message-screen selection operating part 33c is tapped, a message screen displaying update information, maintenance information, etc., which is not shown, is displayed on the display 26. Furthermore, when the present-screen selection operating part 33d is tapped, the present screen shown in FIG. 8 is displayed on the display 26. As will be described later in detail, in the present screen, for example, items distributed from the administrator are displayed.

In the ally-character confirmation screen shown in FIG. 3B, all the images of the ally characters corresponding to ally character IDs associated with the player ID are displayed. That is, in the ally-character confirmation screen, all the ally characters possessed by the player are displayed. Note that the ally character IDs are provided for the identification of ally characters, and thus different IDs are assigned to the individual ally characters. Furthermore, when the player acquires a new ally character, for example, through a gacha lottery, the ally character ID of the acquired ally character is associated with the player ID of the player.

At the right end of the ally-character confirmation screen, a party-screen selection operating part 34 labelled as “Party” is displayed. When the party-screen selection operating part 34 is tapped, a party formation screen, which is not shown, is displayed on the display 26, which makes it possible to form and save a party constituted of five ally characters at most.

For each character, various parameters are stored in association therewith, such as stars (rarity), an experience value, a character level, a skill level, and an equipment rank. The experience value is increased in the case where a battle game has been won or in the case where a prescribed item has been used, which will be described later. The character level is set in accordance with the experience value, and is advanced each time the experience value reaches a prescribed value. Note that, as a proceeding upper limit value, the player level is set to the character level. Therefore, the character level can be advanced within the player level serving as a limit.

Furthermore, each ally character has set therefor base values of battle abilities, such as life points, an offense ability, and a defense ability, on the basis of the stars (rarity) and the character level. The player can proceed with battle games more advantageously as the battle abilities of the ally characters become higher. Furthermore, the individual base values set for an ally character become higher as the stars (rarity) increase and as the character level becomes higher.

Furthermore, each ally character has set therefor four skills that are executed (invoked) in battle games. Each skill has a skill level set therefor, and the effect of the skill becomes higher as the skill level becomes higher. Note that, as a proceeding upper limit value, the character level is set to the skill level. Therefore, the skill level can be advanced within the character level serving as a limit.

Furthermore, each ally character can be equipped with equipment such as a weapon and an armor. Each item of equipment has set therefor a character level at which it is possible to be equipped with that item of equipment, as well as values to be added to the offense ability, the defense ability, etc. By advancing the character level of an ally character, it becomes possible to equip the ally character with a newer and stronger item of equipment, which makes it possible to make the ally character stronger.

When an ally character is equipped with equipment, the additional values of the individual items of equipment are added to the base values mentioned above, which makes it possible to enhance the battle abilities of the ally character. Note that the player can advance the ranks of weapons or the ranks of armors of ally characters. By advancing the ranks of weapons and the ranks of armors, the additional values of the individual items of equipment are increased, which makes it possible to enhance the battle abilities of ally characters. As described above, in this embodiment, the player can increase the number of stars (rarity) and can advance character levels, skill levels, weapon ranks, and armor ranks when empowering ally characters. Note that the first currency is consumed when increasing the number of stars (rarity) of an ally character or advancing the skill level, a weapon rank, or an armor rank of an ally character.

When the room-screen selection operating part 30d is tapped, the room screen shown in FIG. 4 is displayed on the display 26. In the room screen, a room (a game space) 35 serving as the player's own room is displayed. The player can decorate the room 35 by freely installing therein items of furniture 36 purchased by using an in-game currency (a third currency). The third currency serving as the in-game currency can be acquired, for example, through a battle game, which will be described later, as a reward for clearing the battle game. Furthermore, the player can freely dispose favorite ally characters that the player owns in the room 35 so that the player can enjoy various kinds of motion of the ally characters. As described above, the game in this embodiment includes a game element that serves as a customization function (second game content) for the player to decorate (customize) the player's own room in accordance with his or her own preferences.

As shown in FIG. 4, it is possible to dispose items of furniture 36 in the room 35. The items of furniture 36 include items of furniture having special effects that make it possible to advantageously proceed with the game. For example, the items of furniture 36 include potion producing furniture 36a, stamina producing furniture 36b, ticket producing furniture 36c, and first-currency producing furniture 36d.

The potion producing furniture 36a produces a potion every certain period. The potion is used when increasing the experience value of an ally character. The player can acquire the potion produced by the potion producing furniture 36a by tapping the potion producing furniture 36a. The stamina producing furniture 36b produces stamina every certain period. The player can acquire the stamina produced by the stamina producing furniture 36b by tapping the stamina producing furniture 36b, thereby recovering the stamina of the player displayed in the stamina display bar 31b.

The ticket producing furniture 36c produces a skipping ticket every certain period. The player can acquire the skipping ticket produced by the ticket producing furniture 36c by tapping the ticket producing furniture 36c. The skipping ticket will be described in detail when a battle game is described later. The first-currency producing furniture 36d produces the first currency every certain period. The player can acquire the amount of the first currency produced by the first-currency producing furniture 36d by tapping the first-currency producing furniture 36d.

Furthermore, furniture operating parts 37 are displayed in the room screen. The furniture operating parts 37 include a movement operating part 37, an information operating part 37b, a storage operating part 37c, and a first-currency-stock-furniture operating part 37d. The movement operating part 37a is used to change the state of each item of furniture 36 installed in the room 35 to a movement enabled state. The item of furniture 36 in the movement enabled state can be moved to an arbitrary position in the room 35 when a tap operation thereon is performed by the player.

The information operating part 37b is used to display detailed information concerning each item of furniture 36 on the display 26. For example, in the detailed information concerning an item of furniture 36 having a special effect, explanation text for the special effect of the item of furniture 36 is displayed. The storage operating part 37c is used to store each item of furniture 36 installed in the room 35 in a storage box, which is not shown. The stored item of furniture 36 is erased from the room screen. The first-currency-stock-furniture operating part 37d will be described later.

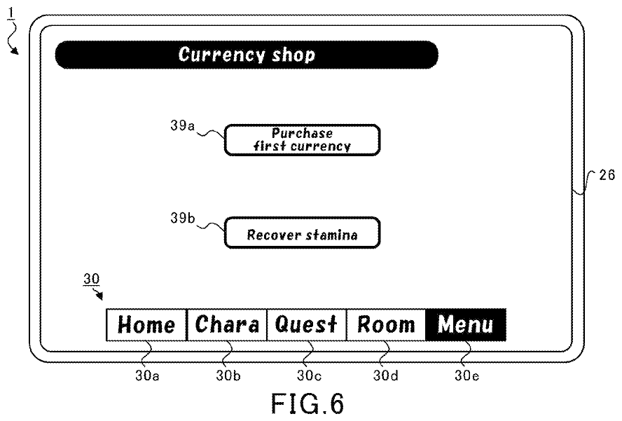

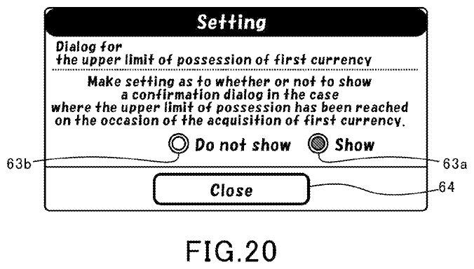

When the menu-screen selection operating part 30e is tapped, the menu screen shown in FIG. 5 is displayed on the display 26. In the menu screen, a currency-shop operating part 38a and a setting operating part 38b are displayed. When the currency-shop operating part 38a is tapped, the currency shop screen shown in FIG. 6 is displayed on the display 26. When the setting operating part 38b is tapped, the setting screen shown in FIG. 20 is displayed on the display 26. The setting screen will be described later.

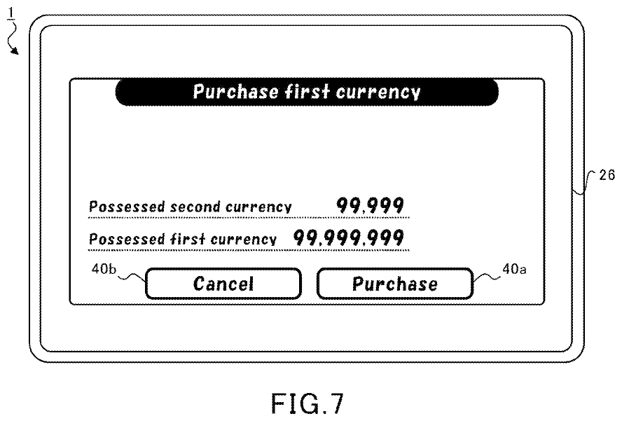

FIG. 6 is an illustration for explaining an example currency shop screen. As shown in FIG. 6, in the currency shop screen, a first-currency purchase operating part 39a and a stamina-recovery operating part 39b are displayed. When the first-currency operating part 39a is tapped, the first-currency purchase screen shown in FIG. 7 is displayed.

FIG. 7 is an illustration showing an example first-currency purchase screen. As shown in FIG. 7, in the first-currency purchase screen, the amount of the first currency currently possessed by the player (hereinafter also referred to as the possessed first currency) and the amount of the second currency currently possessed by the player are displayed. Furthermore, in the first-currency purchase screen, a purchase operating part 40a and a cancel operating part 40b are displayed.

When the purchase operating part 40a is tapped, a fixed amount or a random amount of the first currency is purchased by consuming a prescribed amount of the second currency, the random amount being determined by a lottery or the like. When the cancel operating part 40b is tapped, the purchase of the first currency is cancelled, and the currency shop screen shown in FIG. 6 is displayed. Furthermore, when the stamina-recovery operating part 39b shown in FIG. 6 is tapped, the player's stamina is recovered by a certain value by consuming a prescribed amount of the second currency.

FIG. 8 is a first illustration for explaining an example present screen. When the present-screen selection operating part 33d shown in FIG. 3A is tapped, the present screen shown in FIG. 8 is displayed on the display 26. As shown in FIG. 8, in the present screen, items acquired in in-game content, such as items distributed from the administrator and rewards acquired when battle games such as guild battles were cleared, are displayed. For each item, a reception operating part 41 is displayed in association therewith. When the player taps a reception operating part 41, the player can acquire the item corresponding to the tapped reception operating part 41. Note, however, that when the upper limit value of items that the player can possess has already been reached, the player cannot acquire the item being acquired, and the item is maintained (stored) in the present box.

Furthermore, in the present screen, a receive-all operating part 42a, a cancel operating part 42b, and a history operating part 42c are displayed. When the receive-all operating part 42a is tapped, items that have been stocked in the present box and that have not yet been received by the player are received at once. Also in this case, when the upper limit value of items that the player can possess has been reached, the player cannot receive the items, and the items are maintained in the present box.

When the cancel operating part 42b is tapped, the processing for receiving the items displayed in the present screen is cancelled, and the home screen shown in FIG. 3A is displayed on the display 26. When the history operating part 42c is tapped, the history of receiving items from the present box is displayed.

FIG. 9A is an illustration for explaining an example quest screen for a normal quest. FIG. 9B is an illustration for explaining an example quest selection screen for a normal quest. FIG. 9C is an illustration for explaining an example party selection screen.

When the quest-screen selection operating part 30c is tapped in the home screen shown in FIG. 3A, the quest screen shown in FIG. 9A is displayed on the display 26. Although this embodiment will be described in the context of examples involving three types of battle games, namely, normal quests, hard quests, and very hard quests, other types of battle games (guild battles, etc.) may be provided.

Note that an opening condition is set depending on the type of battle game. Examples of the opening condition include a condition that the player level is greater than or equal to a prescribed value and a condition that the player has cleared prescribed other battle games. Furthermore, a plurality of battle games (layers) belong to each type of battle game. Opening conditions are also set individually for these battle games. Furthermore, when an opening condition is satisfied, game opening information included in the player information is updated.

In the quest screen, the following operating parts are provided: a normal-quest selection operating part 43a for selecting a normal quest; a hard-quest selection operating part 43b for selecting a hard quest; and a very-hard-quest selection operating part 43c for selecting a very hard quest. The quest screen is configured so as to be always in a state where one of the normal-quest selection operating part 43a, the hard-quest selection operating part 43b, and the very-hard-quest selection operating part 43c is selected, and the normal-quest selection operating part 43a is selected in the initial state. Although the following description will be directed to the case where the normal-quest selection operating part 43a is selected, the case where the hard-quest selection operating part 43b or the very-hard-quest selection operating part 43c is selected would be similarly understood.

In the case where the normal-quest selection operating part 43a is selected, quest operating parts 44 for selecting one of the plurality of battle games (layers) belonging to normal quests are displayed in the quest screen.

In the quest operating parts 44, clearing information concerning the individual battle games is also displayed. For example, the clearing information is indicated by using three stars. In a battle game, when the battle game is cleared, stars are acquired in accordance with the number of ally characters whose life points have become zero at the time of clearing. For example, three stars are acquired in the case where there is no ally character whose life points have become zero, two stars are acquired in the case where there is one ally character whose life points have become zero, and one star is acquired in the case where there are two or more ally characters whose life points have become zero.

In the example in FIG. 9A, three stars are acquired in the battle game “21-1”, two stars are acquired in the battle game “21-2”, and two stars are acquired in the battle game “21-3”. Furthermore, no star is acquired in the battle game “21-4”, and it is reported that this battle game has not been cleared.

Note that for each quest (a normal quest, a hard quest, or a very hard quest), an opening condition that the immediately preceding battle game has to be cleared is set. For example, in the example in FIG. 9A, since the battle games up to and including “21-3” have been cleared, the battle game “21-4” is open, but the subsequent battle games (“21-5” and later, which are not shown) are not open.

In the quest screen, for example, when the quest operating part 44 for the battle game “21-1” is operated (tapped), the quest selection screen shown in FIG. 9B is displayed on the display 26. In the quest selection screen, enemy characters that appear in the battle game and an item (reward) that can be acquired in the battle game are displayed. Furthermore, in the quest selection screen, the stamina before and after the execution of the battle game as well as the number of remaining challenges are displayed. The number of remaining challenges indicates the number of challenges allowed in one day, and is set to infinity for normal-quest battle games. Furthermore, in this embodiment, the stamina that is consumed in a normal-quest battle game is set to 10. However, the stamina that is consumed in a normal-quest battle game may be varied among the individual battle games.

Furthermore, in the quest selection screen, a cancel operating part 45 and a challenge operating part 46 for challenging the battle game, labelled as “Challenge”, are displayed.

When the cancel operating part 45 is operated (tapped), the quest screen shown in FIG. 9A is displayed on the display 26, and the challenge to the selected battle game “21-1” is cancelled.

Meanwhile, when the challenge operating part 46 is operated (tapped), the party selection screen shown in FIG. 9C is displayed on the display 26. In the party selection screen, all the ally characters possessed by the player are displayed, and a selected-ally-character display area 48 for displaying selected ally characters are displayed thereunder.

Furthermore, in the party selection screen, a cancel operating part 45 and a battle-start operating part 49 labelled as “Start battle” are displayed.

In the party selection screen, when the player operates (taps) a displayed ally character, the operated ally character is displayed in the selected-ally-character display area 48. That is, here, among the plurality of ally character IDs associated with the player IDs, ally character IDs for use (for party determination) in the battle game are selected.

Furthermore, when the ally characters (ally character IDs) are selected and the battle-start operating part 49 is operated (tapped), the battle game is started.

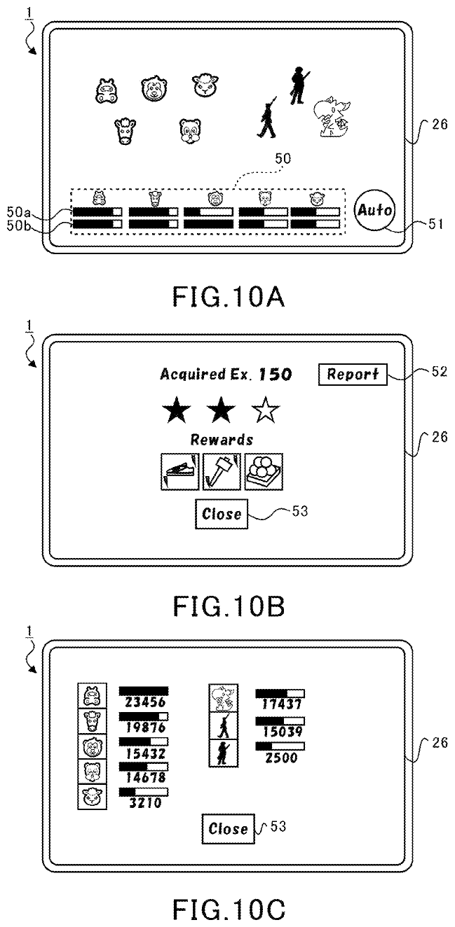

FIG. 10A is an illustration for explaining an example battle screen. FIG. 10B is an illustration for explaining an example result screen. FIG. 10C is an illustration for explaining an example report screen. A battle game is started when the battle-start operating part 49 is operated (tapped) in the party selection screen shown in FIG. 9C.

During the battle game, a battle screen is displayed, as shown in FIG. 10A. In the battle screen, ally characters and enemy characters are displayed on the display 26. The ally characters take actions under computer control, and give damage to the enemy characters and receive damage from the enemy characters. Furthermore, the enemy characters take actions under computer control, and give damage to the ally characters and receive damage from the ally characters.

When damage points are given to an enemy character, the damage points are subtracted from the life points of the enemy character. Similarly, when damage points are given to an ally character, the damage points are subtracted from the life points of the ally character. The player wins (clears) when the life points of all the enemy characters become zero, and the player is defeated when the life points of all the ally characters become zero.

Here, as shown in FIG. 10A, an ally-character display area 50 is provided in a lower part of the battle screen. In the ally-character display area 50, life points 50a and a skill gauge 50b for each of the ally characters are displayed. The skill gauge 50b is increased when the ally character receives damage from an enemy character or gives damage to an enemy character. Furthermore, when the skill gauge 50b reaches a predetermined maximum value, it becomes possible for the ally character to use the skill. The skill may give greater damage points to an enemy character compared with a normal attack, may recover the life points of the ally character, or may exert a special effect on an enemy character.

Here, two patterns are provided as methods for using a skill. In one method, the player operates (taps) an ally character whose skill gauge 50b displayed in the ally-character display area 50 has reached the maximum value. In the other method, when the skill gauge 50b reaches the maximum value in an auto state, the ally character uses the skill under computer control. Note that an auto-selection operating part 51 is displayed in the battle screen, which makes it possible to perform switching between an auto state and a manual state in accordance with operations of the auto-selection operating part 51. When the auto-selection operating part 51 is operated in the manual state, the player enters the auto state, in which the skill is used automatically. Meanwhile, when the auto-selection operating part 51 is operated in the auto state, the player enters the manual state, in which the skill is used manually. Note that even in the auto state, it is possible to use the skill when the player operates (taps) an ally character in a state where the skill gauge 50b has reached the maximum value and the skill has not been used under computer control.

Furthermore, when the battle game is finished normally (normal finish), a result screen is displayed on the display 26, as shown in FIG. 10B. FIG. 10B shows, as an example, a result screen after the battle game is cleared.

In the result screen, the following operating parts are displayed: a report display operating part 52 labelled as “Report”, in which at least a portion of game result information of the battle game, such as acquired experience value information and reward information, is displayed; and a close operating part 53 labelled as “Close”. As shown in FIG. 10B, the reward information includes information concerning items acquired as reward when battle games were cleared, as well as the first currency and the third currency.

The game result information includes: the ally-character IDs of the ally characters (party); the enemy character IDs of the enemy characters; the status of survival of the ally characters and the enemy characters at the end of the battle (whether or not the life points thereof have become zero at the end of the battle game); the given damage points (total values); the distinction as to the manual state or the auto state; a battle log ID; the type of the battle game (a normal quest, a hard quest, a very hard quest, or the like); information (clearing information, the layer of the battle game, etc.) associated with each type of battle game; assigned item information; assigned amounts of the first currency and the third currency, etc. Furthermore, the battle log ID is assigned uniquely to each battle game. Furthermore, the content of the information associated with each type of battle game varies among the individual types of battle games. Furthermore, in the case where a battle game has been cleared, at the server 100, for each item preset in the cleared battle game, it is determined through a lottery whether or not to assign the item to the player. Then, items that are assigned to the player are assigned to the game result information, which is displayed on the result screen.

When the close operating part 53 is operated (tapped) in the result screen, what is displayed on the display 26 is switched from the battle screen to a normal screen. That is, the result screen is a part of the battle screen. The normal screen that is displayed after the switching from the result screen may be the screen that had been displayed immediately before the switching to the battle screen, or a prescribed screen, such as the home screen. When the displayed result screen is closed, as described above, the battle game is finished.

When the report display operating part 52 is operated (tapped) in the result screen, the report screen shown in FIG. 10C is displayed on the display 26. In the report screen, the damage points (total values) given by the ally characters and the enemy characters are displayed, and a close operating part 53 is displayed.

When the close operating part 53 is operated (tapped), the result screen shown in FIG. 10B is displayed on the display 26.

Furthermore, in the quest selection screen shown in FIG. 9B, a ticket display area 47 is provided. In the ticket display area 47, the number of skipping tickets possessed by the player (the number of skipping tickets associated with the player ID) is displayed, and a ticket-using challenge operating part 47a, a minus operating part 47b, and a plus operating part 47c are provided. The ticket-using challenge operating part 47a, the minus operating part 47b, and the plus operating part 47c are enabled only in battle games for which three stars have been acquired as clearing information, and are disabled in battle games for which three stars have not been acquired as clearing information.

In the case where the ticket-using challenge operating part 47a, the minus operating part 47b, and the plus operating part 47c are enabled, each time the plus operating part 47c is operated (tapped), the text indicated in the ticket-using challenge operating part 47a is displayed such that the number of tickets is increased by one, such as “Use two” and “Use three”. Meanwhile, each time the minus operating part 47b is operated (tapped), the text indicated in the ticket-using challenge operating part 47a is displayed such that the number of tickets is decreased by one, such as “Use two” and “Use one”.

Furthermore, for example, when the ticket-using challenge operating part 47a is operated (tapped) in the case where the text indicated in the ticket-using challenge operating part 47a reads “Use five”, the party formation in the party selection screen shown in FIG. 9C and the battle-game execution in the battle screen shown in FIG. 10A are skipped by consuming five tickets and stamina of 50. Then, it is considered that all the (five) battle games have been cleared, and a result screen like the one shown in FIG. 10B is displayed. In the result screen, the items as well as the amounts of the first currency and the third currency acquired in the five battle games are displayed collectively.

As described above, by consuming skipping tickets, battle games for which three stars have been acquired as clearing information are skipped, and it is considered that the battle games have been cleared. This makes it possible for the player to collect items in a shorter time.

As a side note, an upper limit value (hereinafter referred to as the first-currency possession upper limit value) is set to the amount of the first currency that can be possessed by the player. When a player has acquired the first currency and the amount of the first currency possessed by the player exceeds the first-currency possession upper limit value, the excess amount of the first currency is basically transferred to the present box shown in FIG. 8. Here, the first currency is a kind of in-game item and can be stored in the present box. Items also include items other than the first currency, such as the second currency, the third currency, potions, stamina, and tickets, and each of these items is an item that can be stored in the present box. When the upper limit value of items that can be possessed by the player is exceeded, these items are transferred to the present box. Then, the present box can store the items exceeding the upper limit value of items that can be possessed by the player. Here, when the item is the first currency, the upper limit value of items that can be possessed is the first-currency possession upper limit value. As described above, the game in this embodiment includes a game element that serves as a storage function (third game content) for storing items exceeding the upper limit value of items that can be possessed by the player.

However, there are cases where the player frequently acquires the first currency and excess amounts of the first currency exceeding the first-currency possession upper limit value are frequently transferred to the present box.

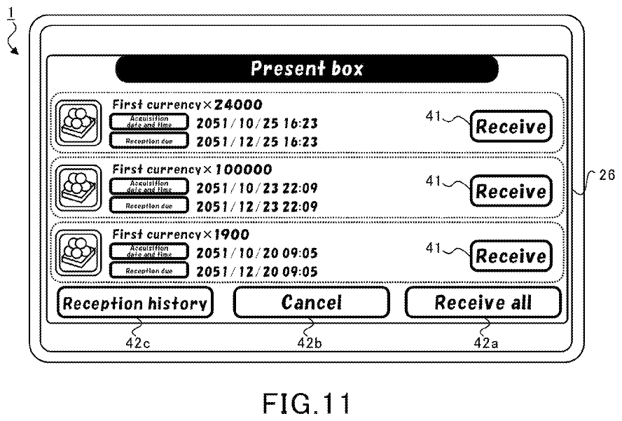

FIG. 11 is a second illustration for explaining an example present screen. As shown in FIG. 11, when amounts of the first currency exceeding the first-currency possession upper limit value are frequently transferred to the present box, the ratio occupied by the display area concerning the first currency in the present screen becomes high, which might compromise the comprehensiveness of the present screen.

Thus, in this embodiment, as shown in FIG. 4, the first-currency stock furniture (stock item) 36e, in which the first currency can be stocked, is provided as a part of the room function (customizing function). In this embodiment, although the first-currency stock furniture 36e will be described in the context of an example where the first currency is stocked; without limitation thereto, however, the first-currency stock furniture 36e may be configured to stock other items, such as the second currency, the third currency, potions, stamina, or tickets. The stock amount of the first currency that can be stocked in the first-currency stock furniture 36e is greater than the upper limit value of the first currency that can be possessed by the player. Alternatively, however, the stock amount of the first currency that can be stocked in the first-currency stock furniture 36e may be the same as or less than the upper limit value of the first currency that can be possessed by the player. For example, in the case where the upper limit value of the first currency that can be possessed by the player is “999,999,999”, the stock amount of the first currency that can be stocked in the first-currency stock furniture 36e is “99,999,999,999”.

Similarly to the other items of furniture 36, the first-currency stock furniture 36e can be purchased by consuming an in-game currency (third currency). In the room screen shown in FIG. 4, the menu operating part 54 is displayed. When the menu operating part 54 is tapped, a room menu screen is displayed in a manner superimposed on the room screen.

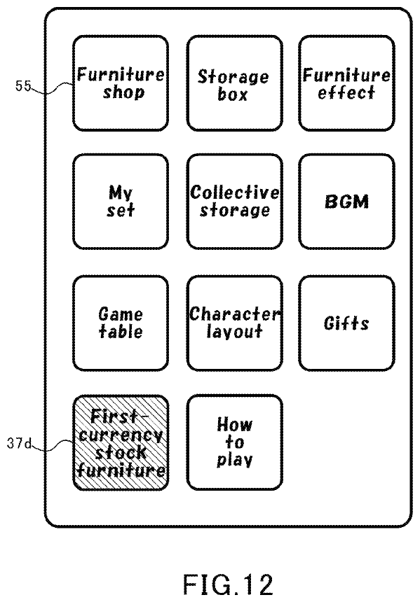

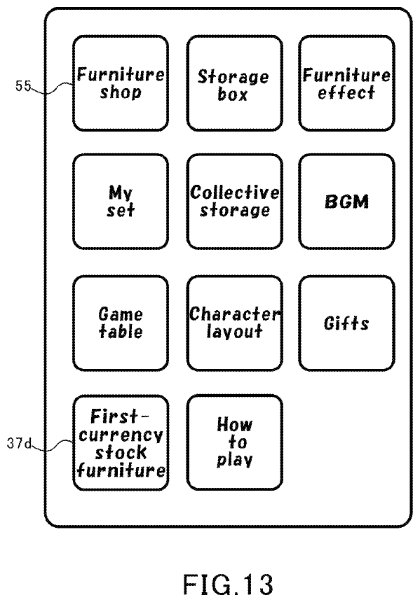

FIG. 12 is a first illustration for explaining an example room menu screen. FIG. 13 is a second illustration for explaining an example room menu screen. As shown in FIG. 12, the room menu screen includes a furniture-shop operating part 55 and a first-currency-stock-furniture operating part 37d.

When the furniture-shop operating part 55 is tapped, a list of items of furniture that can be purchased by the player is displayed, which makes it possible for the player to purchase, for example, the first-currency stock furniture 36e by consuming the in-game currency (third currency).

In the case where the player has not purchased the first-currency stock furniture 36e or in the case where the first currency has not been stocked in the first-currency stock furniture 36e after the first-currency stock furniture 36e was purchased, the first-currency-stock-furniture operating part 37d is displayed in a grayed-out manner, as shown in FIG. 12. In the case where the first-currency-stock-furniture operating part 37d is displayed in a grayed-out manner, the first-currency-stock-furniture operating part 37d is set so as not to be able to accept a tap operation thereon by the player.

In the case where the player has purchased the first-currency stock furniture 36e and the first currency has been stocked in the first-currency stock furniture 36e, the first-currency-stock-furniture operating part 37d is not displayed in a grayed-out manner, as shown in FIG. 13, and is set so as to be able to accept a tap operation thereon by the player.

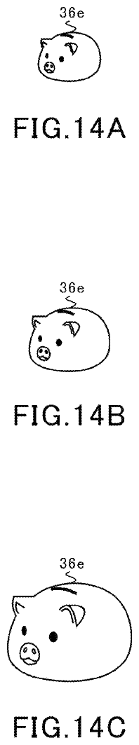

FIG. 14A is a first illustration for explaining an example change in the external shape of the first-currency stock furniture 36e. FIG. 14B is a second illustration for explaining an example change in the external shape of the first-currency stock furniture 36e. FIG. 14C is a third illustration for explaining an example change in the external shape of the first-currency stock furniture 36e.

As shown in FIGS. 14A to 14C, when the first-currency stock furniture 36e is disposed in the room 35, the external shape thereof changes in accordance with the stock amount of the first currency. The external shape of the first-currency stock furniture 36e become larger as the stock amount of the first currency increases. Furthermore, the external shape of the first-currency stock furniture 36e becomes smaller as the stock amount of the first currency decreases. Note that it is possible to stock the first currency even in the state where the first-currency stock furniture 36e has not been installed in the room 35. In the case where the first-currency stock furniture 36e has not been installed in the room 35, however, it is not possible to visually recognize changes in the external shape of the first-currency stock furniture 36e in accordance with the stock amount of the first currency.

In this embodiment, the external shape of the first-currency stock furniture 36e changes each time the stock amount of the first currency reaches a prescribed value. For example, the size becomes the size shown in FIG. 14A in the case where the stock amount in the first-currency stock furniture 36e is less than “10,000,000”. Furthermore, the size becomes the size shown in FIG. 14B in the case where the stock amount in the first-currency stock furniture 36e is greater than or equal to “10,000,000” and less than “100,000,000”. Furthermore, the size becomes the size shown in FIG. 14C in the case where the stock amount in the first-currency stock furniture 36e is greater than or equal to “100,000,000”.

As described above, the size of the first-currency stock furniture 36e becomes a first size, which is the smallest, when the stock amount of the first currency is less than a first prescribed value. Furthermore, the size of the first-currency stock furniture 36e becomes a second size, which is larger than the first size, when the stock amount of the first currency is greater than or equal to the first prescribed value and less than a second prescribed value. Furthermore, the size of the first-currency stock furniture 36e becomes a third size, which is larger than the second size and is the largest, when the stock amount of the first currency is greater than or equal to the second prescribed value. This makes it easy for the player to visually recognize the stock amount of the first currency stocked in the first-currency stock furniture 36e.

Although an example in which the size of the first-currency stock furniture 36e is changed has been described here, without limitation thereto, for example, the appearance (external shape, color, or the like) of the first-currency stock furniture 36e may be changed in accordance with the stock amount of the first currency. Furthermore, the image of the first-currency-stock-furniture operating part 37d shown in FIGS. 4 and 13 does not change depending on the stock amount of the first currency. Alternatively, however, the image of the first-currency-stock-furniture operating part 37d may be changed depending on the stock amount of the first currency, similarly to the first-currency stock furniture 36e.

When the first-currency stock furniture 36e in FIG. 4 or the first-currency-stock-furniture operating part 37d in FIGS. 4 and 13 is tapped, a first-currency withdrawal dialog screen is displayed on the display 26 in order to withdraw the first currency stocked in the first-currency stock furniture 36e. Note that it is possible to withdraw the first currency stocked in the first-currency stock furniture 36e irrespective of whether or not the first-currency stock furniture 36e has been installed in the room 35. For example, after purchasing the first-currency stock furniture 36e, the player can withdraw the stocked first currency from the first-currency stock furniture 36e by tapping the first-currency-stock-furniture operating part 37d shown in FIGS. 4 and 13 even if the first-currency stock furniture 36e has not been installed in the room 35.

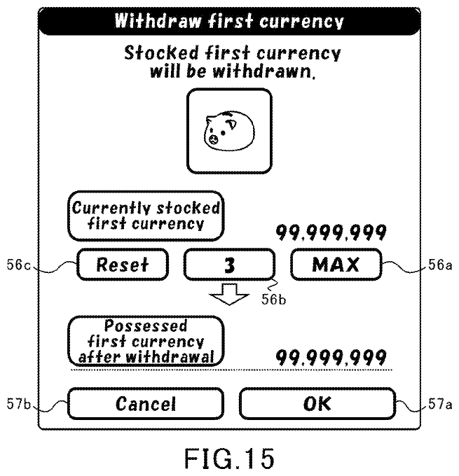

FIG. 15 is an illustration for explaining an example first-currency withdrawal dialog screen. As shown in FIG. 15, in the first-currency withdrawal dialog screen, information indicating the stock amount of the first currency currently stocked in the first-currency stock furniture 36e and information indicating the amount of the first currency possessed by the player after withdrawing the first currency are displayed.

Furthermore, in the first-currency withdrawal dialog screen, a MAX selection operating part 56a, a numerical-value input operating part 56b, a reset selection operating part 56c, a determination selection operating part 57a, and a cancel selection operating part 57b are displayed.

With the MAX selection operating part 56a, the total amount of the first currency currently stocked in the first-currency stock furniture 36e is specified as an amount of the first currency to be withdrawn (withdrawal value) from the first-currency stock furniture 36e. Note, however, that in the case where the amount of the first currency possessed by the player would reach the first-currency possession upper limit value when the first currency were withdrawn from the first-currency stock furniture 36e, the value of difference between the first-currency possession upper limit value and the amount of the first currency currently possessed by the player is specified as the amount of withdrawal.

With the numerical-value input operating part 56b, a value input through an operation by the player is specified as an amount of the first currency to be withdrawn from the first-currency stock furniture 36e. Here, in the case where the value input by the player exceeds the total amount of the first currency currently stocked in the first-currency stock furniture 36e, the value of the total amount is specified as the input value.

With the reset selection operating part 56c, the value specified as the amount of withdrawal of the first currency via the MAX selection operating part 56a and the numerical-value input operating part 56b is reset. The information indicating the stock amount of the first currency and the information indicating the amount of the first currency possessed by the player after withdrawal in the first-currency withdrawal dialog screen change as appropriate in response to operations of the MAX selection operating part 56a, the numerical-value input operating part 56b, and the reset selection operating part 56c.

With the determination selection operating part 57a, it is determined that the amount of the first currency specified via the MAX selection operating part 56a or the numerical-value input operating part 56b is to be withdrawn from the first-currency stock furniture 36e. With the cancel selection operating part 57b, processing for withdrawing the first currency from the first-currency stock furniture 36e is cancelled.

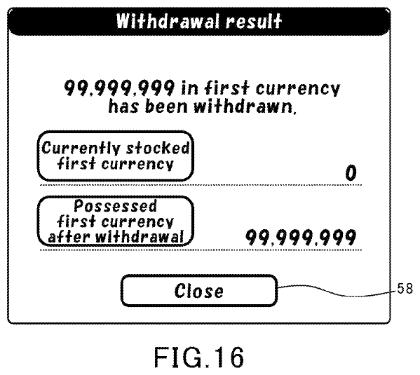

When the determination selection operating part 57a is tapped, processing for withdrawing the first currency is executed, and the withdrawal-result screen shown in FIG. 16 is displayed on the display 26. Note that in the case where the amount of the first currency possessed by the player has reached the first-currency possession upper limit value, the determination selection operating part 57a is displayed in a grayed-out manner and is set so as not to be able to accept a tap operation thereon. At this time, when the determination selection operating part 57a is tapped, a confirmation message to the effect that withdrawal processing is not allowed since the amount of the first currency possessed has reached the first-currency possession upper limit value may be displayed as a dialog.

FIG. 16 is an illustration for explaining an example withdrawal result screen. As shown in FIG. 16, in the withdrawal result screen, a confirmation message to the effect that the specified amount of the first currency has been withdrawn, information indicating the stock amount of the first currency currently stocked in the first-currency stock furniture 36e, and information indicating the amount of the first currency possessed by the player after withdrawing the first currency are displayed. Furthermore, a close selection operating part 58 is displayed in the withdrawal result screen, and the withdrawal result screen is closed when the close selection operating part 58 is tapped.

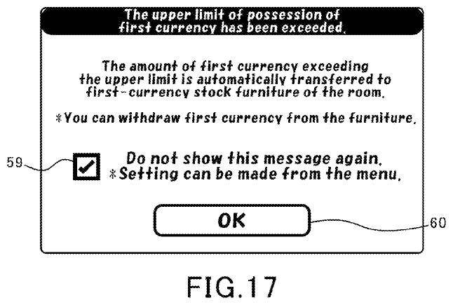

As a side note, as shown in FIG. 10B, when the first currency is given to the player as a reward when a battle game is cleared, there are cases where the amount of the first currency possessed by the player exceeds the first-currency possession upper limit value. When the amount possessed exceeds the first-currency possession upper limit value in the state where the player has purchased (enabled) the first-currency stock furniture 36e, an over-upper-limit dialog screen shown in FIG. 17 is displayed on the display 26.

FIG. 17 is an illustration for explaining an example over-upper-limit dialog screen. As shown in FIG. 17, in the over-upper-limit dialog screen, a confirmation message to the effect that the amount of the first currency possessed by the player has exceeded the first-currency possession upper limit value and a confirmation message to the effect that the first currency exceeding the upper limit value is automatically transferred to the first-currency stock furniture 36e are displayed.

Furthermore, in the over-upper-limit dialog screen, a check box 59 for setting whether or not to display the over-upper-limit dialog screen on later occasions is displayed. The player can check the check box 59 or uncheck the check box 59 by tapping the check box 59. When the check box 59 is checked, the setting is changed so that the over-upper-limit dialog screen will not be displayed on later occasions. When the check box 59 is unchecked, the setting is changed so that the over-upper-limit dialog screen will be displayed on later occasions.

Furthermore, in the over-upper-limit dialog screen, a determination selection operating part 60 is displayed. When the determination selection operating part 60 is tapped, the setting made via the check box 59 is reflected, and the over-upper-limit dialog screen is closed.

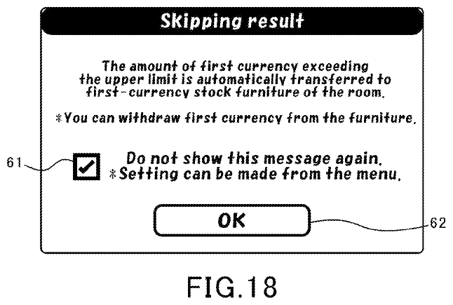

Similarly, as shown in FIG. 9B, when the player is given the first currency as a reward on an occasion when the ticket-using challenge operating part 47a is tapped and the battle game is skipped and cleared, there are cases where the amount of the first currency possessed by the player exceeds the first-currency possession upper limit value. When the amount of the first currency possessed by the player exceeds the first-currency possession upper limit value in the state where the player has purchased (enabled) the first-currency stock furniture 36e, a skipping-result dialog screen shown in FIG. 18 is displayed on the display 26.

FIG. 18 is a first illustration for explaining an example skipping-result dialog screen. As shown in FIG. 18, in the skipping-result dialog screen, a confirmation message is displayed to the effect that in the case where the amount of the first currency possessed by the player exceeds the first-currency possession upper limit value, the excess amount of the first currency is automatically transferred to the first-currency stock furniture 36e.

Furthermore, in the skipping-result dialog screen, a check box 61 for setting whether or not to display the skipping-result dialog screen on later occasions is displayed. The player can check the check box 61 or uncheck the check box 61 by tapping the check box 61. When the check box 61 is checked, the setting is changed so that the skipping-result dialog screen will not be displayed on later occasions. When the check box 61 is unchecked, the setting is changed so that the skipping-result dialog screen will be displayed on later occasions.

Furthermore, in the skipping-result dialog screen, a determination selection operating part 62 is displayed. When the determination selection operating part 62 is tapped, the setting made via the check box 61 is reflected, and the skipping-result dialog screen is closed.

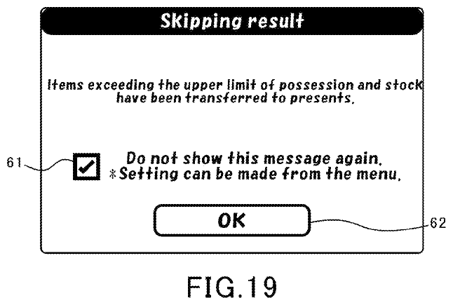

Note that when the first currency is automatically transferred to the first-currency stock furniture 36e, there are cases where the stock amount in the first-currency stock furniture 36e exceeds an upper limit value of stocking (hereinafter referred to as the first-currency stock upper limit value). For example, when a reward is acquired as a result of skipping and clearing a battle game, there are cases where the amount of the first currency possessed by the player exceeds the first-currency possession upper limit value and the stock amount in the first-currency stock furniture 36e exceeds the first-currency stock upper limit value. Furthermore, when a reward is acquired as a result of skipping and clearing a battle game, there are cases where the amount of the first currency possessed by the player exceeds the first-currency possession upper limit value and the player has not purchased the first-currency stock furniture 36e. In these cases, a skipping-result dialog screen shown in FIG. 19 is displayed on the display 26 instead of the one shown in FIG. 18.

FIG. 19 is a second illustration for explaining an example skipping-result dialog screen. As shown in FIG. 19, in the skipping-result dialog screen, a confirmation message is displayed to the effect that the first currency exceeding the first-currency possession upper limit value and the first-currency stock upper limit value is automatically transferred to the present box. Note that when the first currency acquired in the case where a battle game is cleared without being skipped is automatically transferred to the first-currency stock furniture 36e, there are cases where the amount of stock in the first-currency stock furniture 36e exceeds the first-currency stock upper limit value. Furthermore, there are cases where the first currency acquired in the case where a battle game is cleared without being skipped exceeds the first-currency possession upper limit value and the player has not purchased the first-currency stock furniture 36e. In these cases, an over-upper-limit dialog screen including the same content as the content shown in FIG. 19 is displayed instead of the one shown in FIG. 17.

Furthermore, in the skipping-result dialog screen, a check box 61 for setting whether or not to display the skipping-result dialog screen on later occasions is displayed. Furthermore, in the skipping-result dialog screen, a determination selection operating part 62 is displayed. When the determination selection operating part 62 is tapped, the setting made via the check box 61 is reflected, and the skipping-result dialog screen is closed.

When the setting operating part 38b is tapped in the menu screen shown in FIG. 5, a setting screen shown in FIG. 20 is displayed on the display 26.

FIG. 20 is an illustration for explaining an example setting screen. As shown in FIG. 20, in the setting screen, a confirmation message is displayed to the effect that a setting is to be made regarding the displaying of a confirmation dialog in the case where the first-currency possession upper limit value has been reached on the occasion of an acquisition of the first currency. Furthermore, in the setting screen, a display selection operating part 63a for displaying the dialog, a no-display selection operating part 63b for not displaying the dialog, and a close selection operating part 64 are displayed.

When the display selection operating part 63a is tapped, a setting is made so that the over-upper-limit dialog screen shown in FIG. 17 and the skipping-result dialog screens shown in FIGS. 18 and 19 will be displayed when the upper limit value of the amount of the first currency that can be possessed by the player is exceeded on the occasion of an acquisition of the first currency. That is, a setting is made so as to display the dialog screens shown in FIGS. 17 to 19 when the player has acquired the first currency exceeding the first-currency possession upper limit value. Meanwhile, when the no-display selection operating part 63b is tapped, a setting is made so that the over-upper-limit dialog screen shown in FIG. 17 and the skipping-result dialog screens shown in FIGS. 18 and 19 will not be displayed when the upper limit value of the amount of the first currency that can be possessed by the player is exceeded on the occasion of an acquisition of the first currency. That is, a setting is made so as not to display the dialog screens shown in FIGS. 17 to 19 when the player has acquired the first currency exceeding the first-currency possession upper limit value. When the close selection operating part 64 is tapped, either the display setting or the no-display setting is saved, and the setting screen is closed.

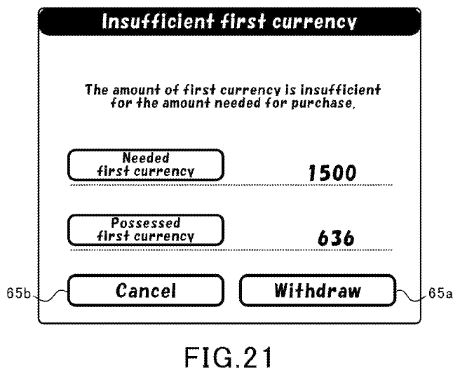

When the shop-screen selection operating part 33a shown in FIG. 3A is tapped, a shop screen that makes it possible to purchase items, which is not shown, is displayed. As described above, the game in this embodiment includes a game element serving as a purchase function (first game content) for the player to purchase in-game items by consuming prices (e.g., the first currency). Here, when the player purchases an item by consuming the first currency, there are cases where the amount of the first currency possessed by the player is not sufficient for the amount needed for purchasing the item. The first-currency stock furniture 36e is configured such that the stocked first currency can be withdrawn therefrom in the case where the player has purchased the first-currency stock furniture 36e and the first currency has been stocked in the first-currency stock furniture 36e. When the stocked first currency is withdrawn from the first-currency stock furniture 36e due to the insufficiency of the first currency in purchasing an item, a first-currency-insufficiency dialog screen shown in FIG. 21 is displayed on the display 26. Note that the present box is configured such that the stored first currency cannot be withdrawn therefrom when the first currency is insufficient for purchasing an item.

FIG. 21 is an illustration for explaining an example first-currency-insufficiency dialog screen. As shown in FIG. 21, in the first-currency-insufficiency dialog screen, a confirmation message to the effect that the first currency needed for purchasing an item is insufficient, information concerning the amount of the first currency needed for purchasing the item, and information concerning the amount of the first currency currently possessed by the player are displayed. Note that the first-currency-insufficiency dialog screen shown in FIG. 21 may be displayed in screens other than the shop screen, such as a screen for empowering an ally character, which is displayed when advancing the stars (rarity), the skill level, the weapon rank, or the armor ranks of an ally character. In any case, the first-currency-insufficiency dialog screen may be displayed in any screen in which the first currency is used in the game. Furthermore, without limitation thereto, an item-insufficiency dialog screen corresponding to the content shown in FIG. 21 may be displayed in a screen in which an item such as a potion or stamina is used in the game in the case where items such as potions or stamina are stocked in the first-currency stock furniture (stock item) 36e.

Furthermore, in the first-currency-insufficiency dialog screen, a withdrawal selection operating part 65a and a cancel selection operating part 65b are displayed. When the withdrawal selection operating part 65a is tapped, the first-currency withdrawal dialog screen shown in FIG. 15 is displayed, which makes it possible to withdraw an arbitrary amount of the first currency from the first-currency stock furniture 36e, as described earlier. That is, the player can withdraw the first currency stocked in the first-currency stock furniture 36e serving as one of the items of furniture 36 while purchasing items in the shop screen, without having to display the room screen shown in FIG. 4. Note that after purchasing the first-currency stock furniture 36e, the player can withdraw the first currency from the first-currency stock furniture 36e by tapping the withdrawal selection operating part 65a shown in FIG. 21 even if the first-currency stock furniture 36e has not been installed in the room 35. When the cancel selection operating part 65b is tapped, the first-currency-insufficiency dialog screen is closed.

As described above, in this embodiment, the first-currency stock furniture 36e is implemented as one of the items of furniture 36 in the room function.

When the player has acquired the first currency as a reward for clearing the battle game shown in FIG. 10B, the first currency is added to the amount of the first currency currently possessed by the player unless the result exceeds the first-currency possession upper limit value.

Meanwhile, in the case where the first-currency possession upper limit value is exceeded, the first currency is added to the stock in the first-currency stock furniture 36e in the case where the player has purchased (owns) the first-currency stock furniture 36e and the first-currency stock upper limit value is not exceeded.

Furthermore, in the case where the first-currency possession upper limit value is exceeded and the first-currency stock upper limit value is exceeded, the first currency is transferred to the present box shown in FIGS. 8 and 11. Furthermore, in the case where the first-currency possession upper limit value is exceeded and the player has not purchased (does not own) the first-currency stock furniture 36e, the first currency is transferred to the present box shown in FIGS. 8 and 11.

When the player has received the first currency from the present box shown in FIGS. 8 and 11, the first currency is added to the amount of the first currency currently possessed by the player unless the result exceeds the first-currency possession upper limit value.

Meanwhile, in the case where the first-currency possession upper limit value is exceeded, the first currency is added to the stock in the first-currency stock furniture 36e in the case where the player has purchased (owns) the first-currency stock furniture 36e and the first-currency stock upper limit value is not exceeded.

Furthermore, in the case where the first-currency possession upper limit value is exceeded and the first-currency stock upper limit value is exceeded, the first currency is not acquired from the present box shown in FIGS. 8 and 11 and is maintained in the present box. Furthermore, in the case where the first-currency possession upper limit value is exceeded and the player has not purchased (does not own) the first-currency stock furniture 36e, the first currency is maintained in the present box instead of being acquired from the present box shown in FIGS. 8 and 11.

When the player has purchased the first currency in the currency purchase screen shown in FIG. 7, the first currency is added to the amount of the first currency currently possessed by the player unless the result exceeds the first-currency possession upper limit value.

Meanwhile, in the case where the first-currency possession upper limit value is exceeded, the first currency is transferred to the present box in the case where the player has purchased (owns) the first-currency stock furniture 36e and the first-currency stock upper limit value is not exceeded. Without limitation thereto, however, the first currency may be added to the stock in the first-currency stock furniture 36e in the case where the player has purchased (owns) the first-currency stock furniture 36e and the first-currency stock upper limit value is not exceeded.

Furthermore, in the case where the first-currency possession upper limit value is exceeded and the first-currency stock upper limit value is exceeded, the first currency is transferred to the present box shown in FIGS. 8 and 11. Furthermore, in the case where the first-currency possession upper limit value is exceeded and the player has not purchased (does not own) the first-currency stock furniture 36e, the first currency is transferred to the present box shown in FIGS. 8 and 11.

Thus, in the case where the amount of the first currency possessed by the player has reached the first-currency possession upper limit value, when the player has acquired the first currency, the first currency is stocked in the first-currency stock furniture 36e, which reduces the frequency of the first currency being transferred to the present box. As a result, it is possible to reduce the ratio of the area occupied by the display area concerning the first currency in the present screen, which alleviates the compromise of the comprehensiveness of the present screen.

Furthermore, since the first currency exceeding the upper limit of possession by the player is stocked in the first-currency stock furniture 36e, which can be used to decorate the room 35, it is possible to improve game intricacies.

Note that the information concerning the first currency owned by the player is managed by the server 100 in association with the player ID. Specifically, in the server 100, player ownership information concerning the amount of the first currency owned by the player, furniture stock information concerning the stock amount of the first currency stocked in the first-currency stock furniture 36e, and present-box storage information concerning the amount of the first currency stored in the present box are each stored in association with the player ID. Furthermore, each time the player acquires the first currency, the server 100 updates the individual items of information associated with the player ID (the player ownership information, the furniture stock information, and the present-box storage information). Note, however, that in the case where the player has purchased the first currency for a charge at the price of cache or the like, the purchased first currency is not stocked in the first-currency stock furniture 36e. In the case where the player has purchased the first currency for a charge, the purchased first currency is owned by the player in the case where the first currency is less than or equal to the first-currency possession upper limit value and is stored (saved) in the present box in the case where the first currency exceeds the first-currency possession upper limit value. Therefore, in the case where the player has purchased the first currency for a charge, the server 100 updates the player ownership information and the present-box storage information in association with the player ID, while not updating the furniture stock information.

Next, the basic configurations of and communication processes at the player terminal 1 and the server 100 will be described. Here, the description will be directed to an example of basic communication processes for proceeding with the game as well as main communication processes concerning free parameter increases, while omitting descriptions of other processes.

### (Functional Configuration of Player Terminal 1)

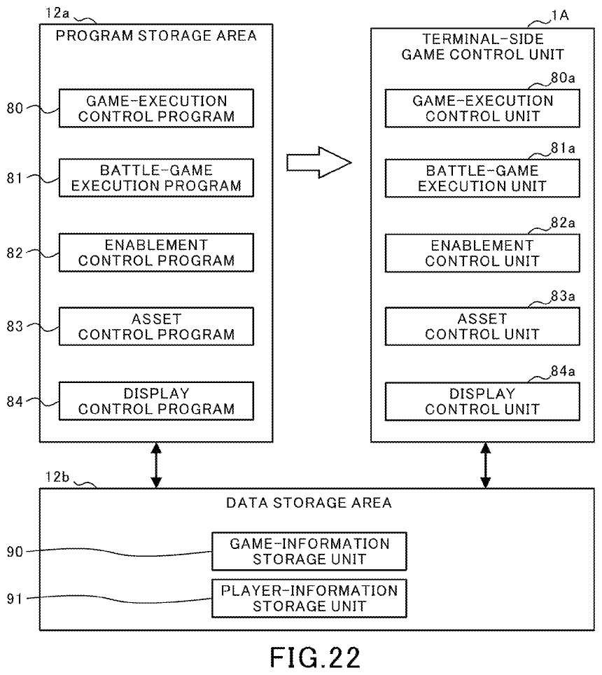

FIG. 22 is a diagram for explaining the configuration of the memory 12 at the player terminal 1, as well as the functions thereof as a computer. In the memory 12, a program storage area 12a and a data storage area 12b are provided. Upon the start of the game, the CPU 10 stores terminal-side game control programs (modules) in the program storage area 12a.

The terminal-side game control programs include a game-execution control program 80, a battle-game execution program 81, an enablement control program 82, an asset control program 83, and a display control program 84. Note that the programs listed in FIG. 22 are examples, and the terminal-side game control programs include a large number of other programs.

In the data storage area 12b, a game-information storage unit 90 and a player-information storage unit 91 are provided as storage units for storing data. Note that the storage units mentioned above are examples, and a large number of other storage units are provided in the data storage area 12b.

The CPU 10 runs the individual programs stored in the program storage area 12a to update the data in the individual storage units in the data storage area 12b. Then, by running the individual programs stored in the program storage area 12a, the CPU 10 causes the player terminal 1 (computer) to function as a terminal-side game control unit 1A. The terminal-side game control unit 1A includes a game-execution control unit 80a, a battle-game execution unit 81a, an enablement control unit 82a, an asset control unit 83a, and a display control unit 84a.

Specifically, the CPU 10 runs the game-execution control program 80, thereby causing the computer to function as the game-execution control unit 80a. Similarly, the CPU 10 runs the battle-game execution program 81, the enablement control program 82, the asset control program 83, and the display control program 84, thereby causing the computer to function as the battle-game execution unit 81a, the enablement control unit 82a, the asset control unit 83a, and the display control unit 84a, respectively.

The game-execution control unit 80a controls the proceeding of the game as a whole. The game-execution control unit 80a transmits log-in information to the server 100, for example, at the time of log-in. Furthermore, the game-execution control unit 80a executes control concerning transitions among normal screens. Furthermore, in the case where game information concerning the game in general has been updated, the game-execution control unit 80a receives the game information from the server 100 and saves the game information in the game-information storage unit 90.

The battle-game execution unit 81a is in charge of control for executing battle games. For example, on the basis of operations input to the player terminal 1, the battle-game execution unit 81a updates battle screens, controls actions of ally characters and enemy characters, and derives damage points.

The enablement control unit 82a enables the first-currency stock furniture 36e when the first-currency stock furniture 36e has been purchased (owned) by the player at the furniture shop. When the first-currency stock furniture 36e has been purchased by the player, the enablement control unit 82a stores ownership information (enablement information) indicating that the player owns the first-currency stock furniture 36e in the player-information storage unit 91 in association with the player ID. The first-currency stock furniture 36e is a special item that makes it possible to stock the first currency, which can be used to empower ally characters or to purchase items. Furthermore, the first-currency stock furniture 36e can be used as an item for decorating the room 35 serving as the player's own room. In other words, the enablement control unit 82a can enable a special item that makes it possible to stock elements to be used in first game content and that are usable as items in second game content. Here, the first game content refers to a function for empowering ally characters and a function for purchasing in-game items. The second game content refers to a room function that makes it possible to customize the room 35 serving as the player's own room. Furthermore, the special item refers to the first-currency stock furniture 36e, which can be installed in the room 35, and the elements refer to the player's assets, such as the first currency, the second currency, the third currency, and stamina needed to start a battle game.

The asset control unit 83a stocks the first currency in the first-currency stock furniture 36e in the case where a prescribed condition is satisfied. In the case where the first-currency stock furniture 36e has been enabled, the asset control unit 83a, irrespective of whether or not the first-currency stock furniture 36e has been installed in the room 35, automatically stocks the first currency in the first-currency stock furniture 36e when the upper limit value of possession of the first-currency that the player can possess has been reached.

Furthermore, the asset control unit 83a, irrespective of whether or not the first-currency stock furniture 36e has been installed in the room 35, can execute processing for withdrawing the first currency stocked in the first-currency stock furniture 36e in the shop screen or the room screen. In other words, the asset control unit 83a, irrespective of whether or not the first-currency stock furniture 36e has been installed in the room 35, can execute processing for withdrawing the first currency stocked in the first-currency stock furniture 36e in the first game content or the second game content.

Furthermore, in the case where the first-currency stock furniture 36e has not been enabled, the asset control unit 83a performs processing for saving the amount of the first currency exceeding the first-currency possession upper limit value in the present box. Furthermore, when the stock amount of the first currency has reached the first-currency stock upper limit value, the asset control unit 83a performs processing for saving the amount of the first currency exceeding the first-currency stock upper limit value in the present box. As described above, the present box is a game element having a storage function for storing, for example, items distributed from the administrator and items exceeding the number of items that can be possessed by the player (third game content). In other words, in the case where the first-currency stock furniture 36e has not been enabled or when the stock amount of the first currency has reached the first-currency stock upper limit value, the asset control unit 83a performs processing for saving the amount of the first currency exceeding the first-currency possession upper limit value or the first-currency stock upper limit value in the third game content. Note that, in this embodiment, in the case where the first currency possessed by the player is insufficient when purchasing an item in the shop screen (first game content) for purchasing an item, the asset control unit 83a cannot perform processing for withdrawing the first currency saved in the present box.

Furthermore, the asset control unit 83a can execute processing for withdrawing the first currency in the shop screen via a special withdrawal operating part (the withdrawal selection operating part 65a in FIG. 21), which functions in the case where the first-currency stock furniture 36e has been enabled. Furthermore, each time the player acquires the first currency, the asset control unit 83a updates individual items of information (player possession information, furniture stock information, and present-box storage information) and stores the updated information in the player-information storage unit 91 in association with the player ID.

The display control unit 84a generates a screen to be displayed on the display 26 and causes the display 26 to display the generated screen. The display control unit 84a can execute a process for changing the appearance of the first-currency stock furniture 36e installed in the room 35 in accordance with the stock amount in the first-currency stock furniture 36e. Furthermore, the display control unit 84a can execute processing for causing the display to display the first-currency-insufficiency dialog screen and the special withdrawal operating part (the withdrawal selection operating part 65a) shown in FIG. 21 when the amount of the first currency possessed by the player is insufficient when purchasing an item in the shop screen. Furthermore, the display control unit 84a can execute processing for causing the display 26 to display various dialog screens in the case where the amount of the first currency possessed by the player has exceeded the upper limit value.

### (Functional Configuration of Server 100)

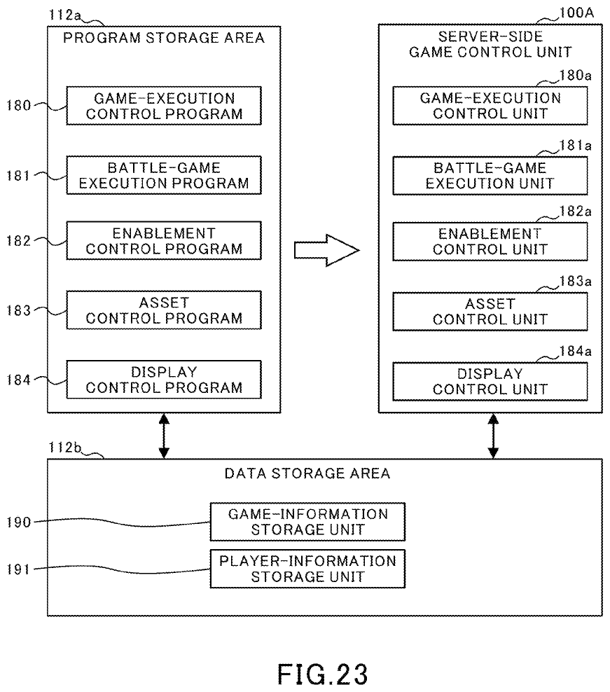

FIG. 23 is a diagram for explaining the configuration of the memory 112 at the server 100, as well as the functions thereof as a computer. In the memory 112, a program storage area 112a and a data storage area 112b are provided. Upon the start of the game, the CPU 110 stores server-side game control programs (modules) in the program storage area 112a.

The server-side game control programs include a game-execution control program 180, a battle-game execution program 181, an enablement control program 182, an asset control program 183, and a display control program 184. Note that the programs listed in FIG. 23 are examples, and the server-side game control programs include a large number of other programs.

In the data storage area 112b, a game-information storage unit 190 and a player-information storage unit 191 are provided as storage units for storing data. Note that the storage units mentioned above are examples, and a large number of other storage units are provided in the data storage area 112b.

The CPU 110 runs the individual programs stored in the program storage area 112a to update the data in the individual storage units in the data storage area 112b. Then, by running the individual programs stored in the program storage area 112a, the CPU 110 causes the server 100 to function as a server-side game control unit 100A. The server-side game control unit 100A includes a game-execution control unit 180a, a battle-game execution unit 181a, an enablement control unit 182a, an asset control unit 183a, and a display control unit 184a.

Specifically, the CPU 110 runs the game-execution control program 180, thereby causing the computer to function as the game-execution control unit 180a. Similarly, the CPU 110 runs the battle-game execution program 181, the enablement control program 182, the asset control program 183, and the display control program 184, thereby causing the computer to function as the battle-game execution unit 181a, the enablement control unit 182a, the asset control unit 183a, and the display control unit 184a, respectively.

The game-execution control unit 180a controls the proceeding of the game as a whole. For example, upon receiving log-in information from the player terminal 1, the game-execution control unit 180a makes it possible for the player terminal 1 to download the player information saved in the player-information storage unit 191 from the server 100. Furthermore, in the case where game information concerning the game in general has been updated, the game-execution control unit 180a reads out the updated game information from the game-information storage unit 190 and makes it possible for the player terminal 1 to download the game information from the server 100.

The battle-game execution unit 181a is in charge of control for executing battle games.

Since the enablement control unit 182a, the asset control unit 183a, and the display control unit 184a have the same functions as the enablement control unit 82a, the asset control unit 83a, and the display control unit 84a described earlier, detailed descriptions thereof will be omitted. Note that when the first-currency stock furniture 36e is purchased by the player, the enablement control unit 182a stores ownership information (enablement information) indicating that the player owns the first-currency stock furniture 36e in the player-information storage unit 191 in association with the player ID. Furthermore, each time the player acquires the first currency, the asset control unit 183a updates individual items of information (player possession information, furniture stock information, and present-box storage information) and stores the updated information in the player-information storage unit 191 in association with the player ID.

### (Communication Processes Between Player Terminal 1 and Server 100)

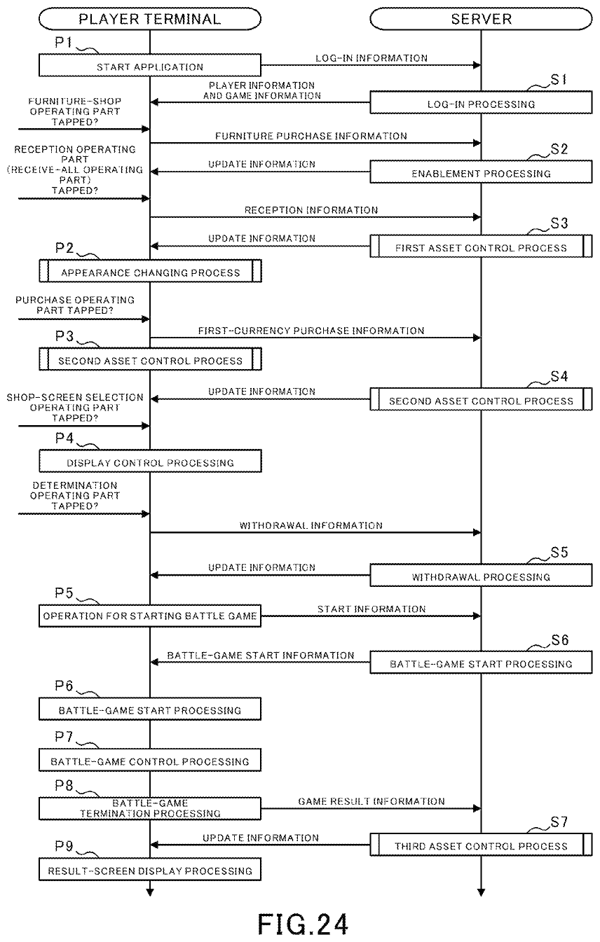

FIG. 24 is a sequence chart for explaining basic processes of the player terminal 1 and the server 100. In the following description, processing that is carried out at the player terminal 1 will be signified by Pn (n is an arbitrary integer). Furthermore, processing that is carried out at the server 100 will be signified by Sn (n is an arbitrary integer).

When the player has started a game application at the player terminal 1 (P1), the game-execution control unit 80a transmits log-in information to the server 100. Upon receiving the log-in information, the game-execution control unit 180a of the server 100 identifies the player ID associated with the log-in information and performs log-in processing (S1). Here, the game-execution control unit 180a reads out the player information corresponding to the identified player ID from the player-information storage unit 191 and makes it possible for the player terminal 1 to download the player information from the server 100. Furthermore, in the case where the game information stored in the game-information storage unit 190 has been changed, the game-execution control unit 180a makes it possible for the player terminal 1 to download the changed game information from the server 100.

When the furniture-shop operating part 55 is tapped at the player terminal 1 and the first-currency stock furniture 36e has been purchased by the player, the enablement control unit 82a transmits furniture purchase information to the server 100. Upon receiving the furniture purchase information, the enablement control unit 182a of the server 100, considering that the player has purchased and owned the first-currency stock furniture 36e, performs processing for enabling the first-currency stock furniture 36e (S2). The enablement processing is, for example, processing for updating and saving the ownership information (enablement information) of the first-currency stock furniture 36e in association with the player ID. The enablement control unit 182a makes it possible for the player terminal 1 to download the updated player information as update information from the server 100.

When the reception operating part 41 or the receive-all operating part 42a has been tapped at the player terminal 1 and an operation for acquiring the first currency from the present box has been performed, the asset control unit 83a transmits reception information to the server 100. Upon receiving the reception information, the asset control unit 183a of the server 100 executes a first asset control process (S3).

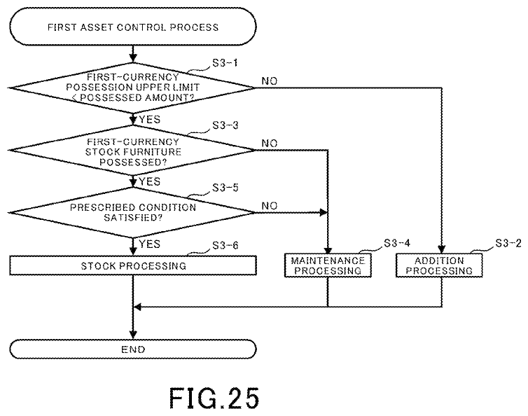

FIG. 25 is a flowchart for explaining an example first asset control process. As shown in FIG. 25, the asset control unit 183a determines whether or not the amount of the first currency possessed by the player after receiving the first currency is greater than the first-currency possession upper limit value (S3-1). In the case where the amount possessed is less than or equal to the first-currency possession upper limit value (NO in S3-1), the asset control unit 183a executes addition processing for adding the received amount of the first currency to the amount of the first currency currently possessed by the player (S3-2).

In the case where the amount possessed is greater than the first-currency possession upper limit value (YES in S3-1), the asset control unit 183a determines whether or not the player possesses the first-currency stock furniture 36e (S3-3). In the case where the first-currency stock furniture 36e is not possessed (NO in S3-3), the asset control unit 183a, considering that it is not possible to receive the first currency from the present box, executes maintenance processing for maintaining the first currency in the present box (S3-4).

In the case where the first-currency stock furniture 36e is possessed (YES in S3-3), the asset control unit 183a determines whether or not a prescribed condition with which it is possible to stock the received amount of the first currency in the first-currency stock furniture 36e is satisfied (S3-5). The prescribed condition is, for example, the condition that the stock amount in the first-currency stock furniture 36e after receiving the first currency is less than or equal to the first-currency stock upper limit value. In the case where the prescribed condition is satisfied (YES in S3-5), the asset control unit 183a executes stock processing for adding the received amount of the first currency to the stock amount in the first-currency stock furniture 36e to stock the first currency (S3-6). In the case where the prescribed condition is not satisfied (NO in S3-5), the asset control unit 183a, considering that it is not possible to receive the amount of the first currency from the present box, executes maintenance processing for maintaining the first currency in the present box (S3-4). Furthermore, the asset control unit 183a updates the player information with the various kinds of information changed through the processing in S3-2, S3-6, and S3-8, and makes it possible for the player terminal 1 to download the updated player information as update information from the server 100.

Referring back to FIG. 24, at the player terminal 1, the display control unit 84a performs an appearance changing process when the stock amount in the first-currency stock furniture 36e has changed beyond a prescribed value (P2).

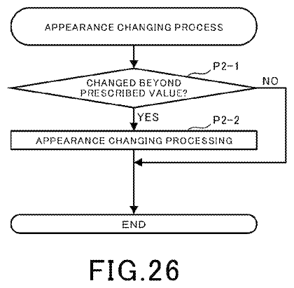

FIG. 26 is a flowchart for explaining an example appearance changing process. As shown in FIG. 26, the display control unit 84a determines whether or not the stock amount in the first-currency stock furniture 36e has changed beyond a prescribed value (P2-1). In the case where the stock amount has changed beyond the prescribed value (YES in P2-1), the display control unit 184a executes an appearance changing process for changing the appearance of the first-currency stock furniture 36e, for example, as shown in FIG. 14A to 14C (P2-2). Meanwhile, in the case where the stock amount has not changed beyond the prescribed value (NO in P2-1), the display control unit 84a finishes the appearance changing process without changing the appearance of the first-currency stock furniture 36e. The appearance changing process is executed by the display control unit 84a each time update information is acquired from the server 100. Specifically, the appearance changing process is executed by the display control unit 84a after a second asset control process (S4), withdrawal processing (S5), and a third asset control process (S7), which will be described later.

Furthermore, when the purchase operating part 40a has been tapped at the player terminal 1 and the first currency has been purchased by the player, the asset control unit 83a transmits first-currency purchase information to the server 100. Upon receiving the first-currency purchase information, the asset control unit 183a of the server 100, considering that the player has purchased the first currency by consuming an amount of the second currency, executes a second asset control process (S4).

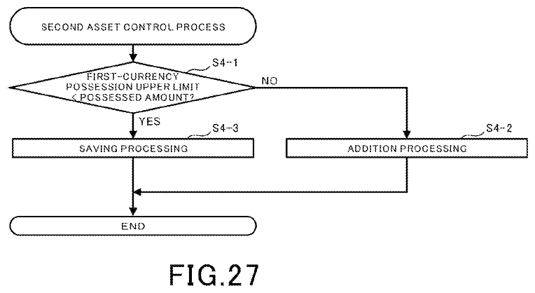

FIG. 27 is a flowchart for explaining an example second asset control process. As shown in FIG. 27, the asset control unit 183a determines whether or not the amount of the first currency possessed by the player after purchasing the first currency is greater than the first-currency possession upper limit value (S4-1). In the case where the amount possessed is less than or equal to the first-currency possession upper limit value (NO in S4-1), the asset control unit 183a executes addition processing for adding the purchased amount of the first currency to the amount of the first currency currently possessed by the player (S4-2).

In the case where the amount possessed is greater than the first-currency possession upper limit value (YES in S4-1), the asset control unit 183a, irrespective of whether or not the player possesses the first-currency stock furniture 36e, executes saving processing for saving the purchased amount of the first currency in the present box (S4-3). Furthermore, the asset control unit 183a updates the player information with the various kinds of information changed through the processing in S4-2 and S4-3, and makes it possible for the player terminal 1 to download the updated player information as update information from the server 100.

Referring back to FIG. 24, when the purchase operating part 40a has been tapped, the asset control unit 83a of the player terminal 1, while the purchase of the amount of the first currency is being rendered on the display 26, executes a process similar to the second asset control process described with reference to FIG. 27 (P3). Note, however, that the player information updated through the process in P3 is overwritten with the player information updated through the processing in S4 and downloaded from the server 100 before being saved.

When the shop-screen selection operating part 33a has been tapped at the player terminal 1 and the amount of the first currency possessed by the player is insufficient when purchasing an item in the shop screen, the display control unit 84a executes display control processing (P4). In the display control processing, the display control unit 84a displays the first-currency-insufficiency dialog screen shown in FIG. 21 on the display 26. Furthermore, when the withdrawal selection operating part 65a has been tapped in the first-currency-insufficiency dialog screen and the determination selection operating part 57a has been tapped in the first-currency withdrawal dialog screen shown in FIG. 15, the asset control unit 83a transmits withdrawal information to the server 100.

Upon receiving the withdrawal information, the asset control unit 183a of the server 100 executes withdrawal processing for withdrawing the first currency from the first-currency stock furniture 36e (55). Furthermore, the asset control unit 183a updates the player information with stock information concerning the stock amount in the first-currency stock furniture 36e, changed through the withdrawal processing, and makes it possible for the player terminal 1 to download the updated player information as update information from the server 100.

Suppose that an operation for starting a battle game has been performed at the player terminal 1 (P5). In this case, start information is transmitted from the player terminal 1 to the server 100. Note that the start information includes party information selected by the player, type information of the battle game, etc. The server 100, in response to the input of the start information, makes it possible for the player terminal 1 to download battle-game start information needed for starting the battle game from the server 100 (56). Then, upon receiving the battle-game start information, the battle-game execution unit 81a of the player terminal 1 executes battle-game start processing for starting the battle game (P6). Here, for example, an area of the memory 12 for proceeding with the battle game is allocated, and prescribed programs are loaded from the storage unit 18 into the memory 12.

Then, the battle-game execution unit 81a of the player terminal 1 executes battle-game control processing for controlling the battle game (P7). In the battle-game control processing, update processing for updating various kinds of information is executed repeatedly on a per-frame basis. The number of frames is not particularly limited, and for example, the number of frames per second is 30 to 60. Therefore, during the battle game, information is updated approximately every 16 ms (milliseconds) to 33 ms at the player terminal 1.

Furthermore, when a condition for finishing the battle game is satisfied, the battle-game execution unit 81a of the player terminal 1 executes battle-game finish processing for finishing the battle game (P8). In the battle-game finish processing, for example, game result information is transmitted to the server 100. Furthermore, the display control unit 84a of the player terminal 1 displays a result screen on the display 26 (P9).

Upon receiving the game result information, the battle-game execution unit 181a of the server 100 updates the player information and executes a third asset control process (S7).

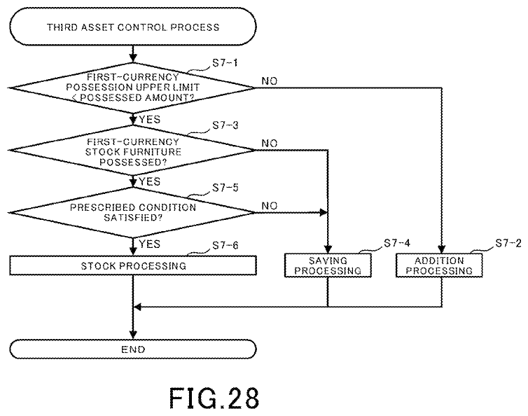

FIG. 28 is a flowchart for explaining an example third asset control process. Here, the third asset control process is a process that is similar to the first asset control process shown in FIG. 25, and thus descriptions of commonalities with the first asset control process will be omitted, and the description will be directed to only a difference from the first asset control process. Specifically, the third asset control process differs in that the maintenance processing in S3-4 in the first asset control process is changed to saving processing in S7-4 shown in FIG. 28.

In FIG. 28, after YES in S7-1, in the case where the first-currency stock furniture 36e is not possessed (NO in S7-3) or in the case where a prescribed condition is not satisfied (NO in S7-5), the asset control unit 183a executes saving processing for saving the first currency received as a reward for clearing the battle game in the present box (S7-4).

As described above, the player terminal 1 is provided with the game-execution control program 80, the battle-game execution program 81, the enablement control program 82, the asset control program 83, and the display control program 84. Furthermore, the player terminal 1 includes the game-execution control unit 80a, the battle-game execution unit 81a, the enablement control unit 82a, the asset control unit 83a, and the display control unit 84a. However, some or all of these programs and functional units may be provided in the server 100. That is, each of these programs and functional units may be provided in one of the player terminal 1 and the server 100 or in both.

Furthermore, the server 100 is provided with the game-execution control program 180, the battle-game execution program 181, the enablement control program 182, the asset control program 183, and the display control program 184. Furthermore, the server 100 includes the game-execution control unit 180a, the battle-game execution unit 181a, the enablement control unit 182a, the asset control unit 183a, and the display control unit 184a. However, some or all of these programs and functional units may be provided in the player terminal 1. That is, each of these programs and functional units may be provided in one of the player terminal 1 and the server 100 or in both.

Note that the information processing program in the embodiment described above may be stored in a computer-readable storage medium and may be provided in the form of the storage medium. Furthermore, the information processing program may be provided in the form of a player terminal or an information processing system including the storage medium. Alternatively, the embodiment described above may be embodied in the form of an information processing method for realizing the individual functions and the steps shown in the flowcharts.

Although an aspect of an embodiment has been described above with reference to the accompanying drawings, it goes without saying that the present invention is not limited to the embodiment described above. It would be obvious that a person skilled in the art could conceive of various kinds of modifications or improvements within the scope recited in the claims, and it would be understood that those modifications and improvements obviously fall within the technical scope of the present invention.

What is claimed is:

1. A non-transitory computer readable medium storing a program causing a computer to execute:
processing for enabling a special item in which an element for use in first game content can be stocked and that is usable as an item for second game content; and
processing for stocking the element in the special item in the case where a prescribed condition is satisfied.

2. The non-transitory computer readable medium according to claim 1, wherein:
the second game content is a customization function that makes it possible to customize a game space,
the special item is a stock item that can be installed in the game space,
the element is an asset of a player, and
in the processing for stocking, in the case where the special item has been enabled and the asset has reached an upper limit value of possession by the player, the asset is automatically stocked in the stock item irrespective of whether or not the stock item has been installed in the game space.

3. The non-transitory computer readable medium according to claim 2,
wherein the program causes the computer to execute:
processing for changing an appearance of the stock item installed in the game space in accordance with a stock amount in the stock item.

4. The non-transitory computer readable medium according to claim 2,
wherein the program causes the computer to execute:
processing for withdrawing the asset stocked in the stock item in the first game content or the second game content irrespective of whether or not the stock item has been installed in the game space.

5. The non-transitory computer readable medium according to claim 3,
wherein the program causes the computer to execute:
processing for withdrawing the asset stocked in the stock item in the first game content or the second game content irrespective of whether or not the stock item has been installed in the game space.

6. The non-transitory computer readable medium according to claim 4,
wherein the program causes the computer to execute:
processing for saving the asset exceeding the upper limit value of possession or an upper limit value of stock in the stock item in third game content in the case where the stock item has not been enabled or in the case where a stock amount of the asset has reached the upper limit value of stock, and
wherein, in the processing for withdrawing, it is prohibited in the first game content to withdraw the asset saved in the third game content.

7. The non-transitory computer readable medium according to claim 5,
wherein the program causes the computer to execute:
processing for saving the asset exceeding the upper limit value of possession or an upper limit value of stock in the stock item in third game content in the case where the stock item has not been enabled or in the case where a stock amount of the asset has reached the upper limit value of stock, and
wherein, in the processing for withdrawing, it is prohibited in the first game content to withdraw the asset saved in the third game content.

8. The non-transitory computer readable medium according to claim 4,
wherein the processing for withdrawing is executable via a special withdrawal operating part that functions in the case where the stock item has been enabled in the first game content.

9. The non-transitory computer readable medium according to claim 5,
wherein the processing for withdrawing is executable via a special withdrawal operating part that functions in the case where the stock item has been enabled in the first game content.

10. The non-transitory computer readable medium according to claim 6,
wherein the processing for withdrawing is executable via a special withdrawal operating part that functions in the case where the stock item has been enabled in the first game content.

11. The non-transitory computer readable medium according to claim 7,
wherein the processing for withdrawing is executable via a special withdrawal operating part that functions in the case where the stock item has been enabled in the first game content.

12. The non-transitory computer readable medium according to claim 8,
wherein the first game content is a function for purchasing an in-game item, and
wherein the program causes the computer to execute:
processing for displaying the special withdrawal operating part on a display when the asset is insufficient for purchasing the item.

13. The non-transitory computer readable medium according to claim 9,
wherein the first game content is a function for purchasing an in-game item, and
wherein the program causes the computer to execute:
processing for displaying the special withdrawal operating part on a display when the asset is insufficient for purchasing the item.

14. The non-transitory computer readable medium according to claim 10,
wherein the first game content is a function for purchasing an in-game item, and
wherein the program causes the computer to execute:
processing for displaying the special withdrawal operating part on a display when the asset is insufficient for purchasing the item.

15. The non-transitory computer readable medium according to claim 11,
wherein the first game content is a function for purchasing an in-game item, and
wherein the program causes the computer to execute:
processing for displaying the special withdrawal operating part on a display when the asset is insufficient for purchasing the item.

16. An information processing method that is carried out by one or more computers, the information processing method comprising:
processing for enabling a special item in which an element for use in first game content can be stocked and that is usable as an item for second game content; and
processing for stocking the element in the special item in the case where a prescribed condition is satisfied.

17. An information processing system including one or more computers,
wherein the one or more computers carry out:
processing for enabling a special item in which an element for use in first game content can be stocked and that is usable as an item for second game content; and
processing for stocking the element in the special item in the case where a prescribed condition is satisfied.
